(19) United States
(12) Patent Application Publication
(10) Pub. No.: US 2019/0003564 A1
(43) Pub. Date: Jan. 3, 2019

(54) CONTINUOUSLY VARIABLE TRANSMISSION WITH UNIFORM INPUT-TO-OUTPUT RATIO THAT IS NON- DEPENDENT ON FRICTION

(71) Applicants: Raja Ramanujam Rajendran, Troy, MI (US); Prashanth Ram Rajendran, Troy, MI (US)

(72) Inventors: Raja Ramanujam Rajendran, Troy, MI (US); Prashanth Ram Rajendran, Troy, MI (US)

(21) Appl. No.: 15/946,567

(22) Filed: Apr. 5, 2018

Related U.S. Application Data
(63) Continuation-in-part of application No. 15/455,201, filed on Mar. 10, 2017.

(51) Int. Cl. F16H 29/20; F16H 29/04; F16H 29/08; F16H 29/14; F16H 29/18; F16H 19/04; F16H 21/36; F16H 53/06

(52) U.S. Cl. CPC F16H 29/20; F16H 29/04; F16H 29/08; F16H 29/14; F16H 2035/003; F16H 19/043; F16H 21/36; F16H 53/06; F16H 29/18

(57) ABSTRACT

This invention is an all gear infinitely variable transmission that is non-dependent on friction. It can me be used in high torque applications. It offers a steady and uniform output for a steady and uniform input. It allows a co-axial input and output thereby by using a planetary gear system the output can be made continuous from forward to reverse. This uses a “scotch-yoke” mechanism to convert rotational motion to a linear reciprocating motion. The linear distance of this reciprocating motion-“stroke” is changed by altering the crankpin location of the scotch-yoke mechanism. This reciprocating motion is converted to a rocking motion by using a “rack and pinion” and later converted to a unidirectional motion via a One-Way-Bearing. A set of non-circular gears are used to achieve a steady and uniform output. It employs a very simple mechanism to change the ratio between the input and output of the transmission.

### CROSS REFERENCE TO RELATED APPLICATIONS

1. Provisional Application
Application No. 61788563
Title: Continuous variable transmission 2. Non-Provisional Application
Application Ser. No. 16/261970
Title: Continuously variable transmission

3. Continuation In Part Application
Application Ser. No. 15/455201
Title: Continuously variable transmission

### BACKGROUND OF THE INVENTION

### Field of the Invention

This invention pertains to transmissions having variable ratios between input and output velocities. Specifically, it relates to all-gear transmissions whose velocity ratios may be changed continuously over a wide range of values ranging from zero to non-zero values, without depending on friction.

### Description of the Related Art

The patents U.S. Pat. No. 5,603,240 and US 20100199805 use some of the features used in this design. The advantages in this invention include:

The patent U.S. Pat. No. 5,603,240 does not have a co-axial input to output and therefore cannot be used for applications requiring this configuration. The output travels as the ratio is changed. Therefore, this design cannot be used when stationary output is required. This new invention offers a stationary and co-axial input and output shaft. The envelope used in this invention is comparably smaller than that of the prior art.

US 20100199805 offers a sinusoidal output and uses several modules just to minimize the “ripple” when a steady and uniform input is provided. Therefore, the design cannot be used when a steady and uniform output is desired. This new invention offers a steady and uniform output when the input is steady and uniform. This can be achieved with as few as three modules namely Rectifier-Modules. (FIG. 87). This is explained in detail in the subsequent paragraphs.

### BRIEF SUMMARY OF THE INVENTION

The main objective of this invention is to provide a UNIFORM and STEADY output, when the input is uniform and steady, with the ability to transmit high torque without depending on friction or friction factor. Many of the continuously variable transmissions that are in the market today are friction dependent and therefor lack the ability to transmit high torque. Those continuously variable transmissions, which are non-friction dependent do not have a uniform and steady output when the input is uniform and steady. This design aids reduction in the overall size and can be economically mass produced. This design can be easily integrated into r system This design is very versatile and can be used ranging from light duty to heavy duty applications. This design allows replacement of existing regular transmission, requiring very little modification. This design offers stationary and co-axial input and output.

BRIEF DESCRIPTION OF THE SEVERAL VIEWS OF THE DRAWINGS:

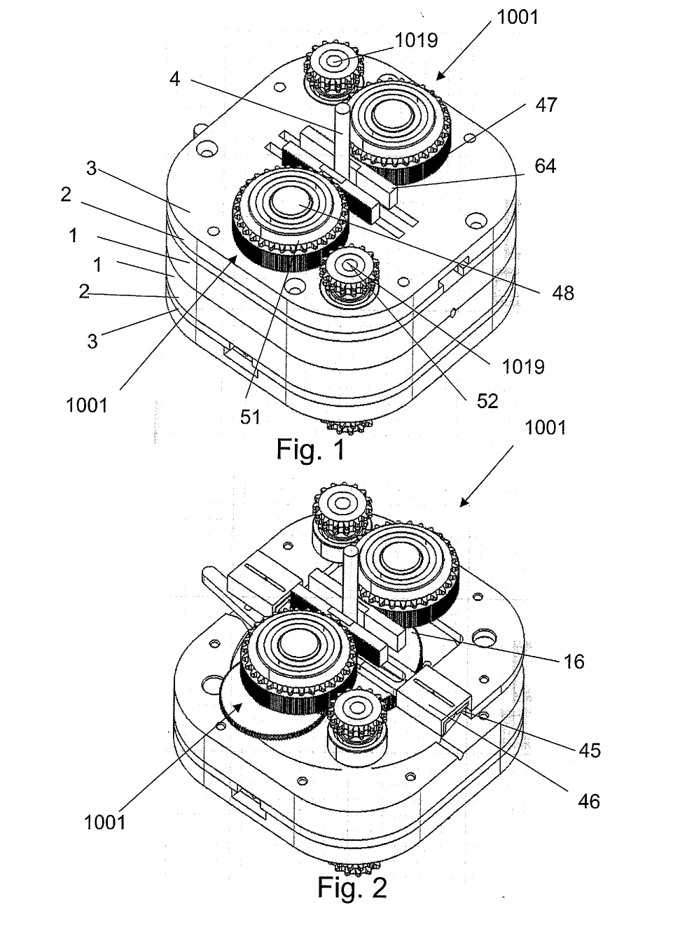

FIG. 1—CVT general sequential assembly perspective view.

FIG. 2—CVT general sequential assembly perspective view with frames made transparent showing general arrangement of internal sub-assemblies.

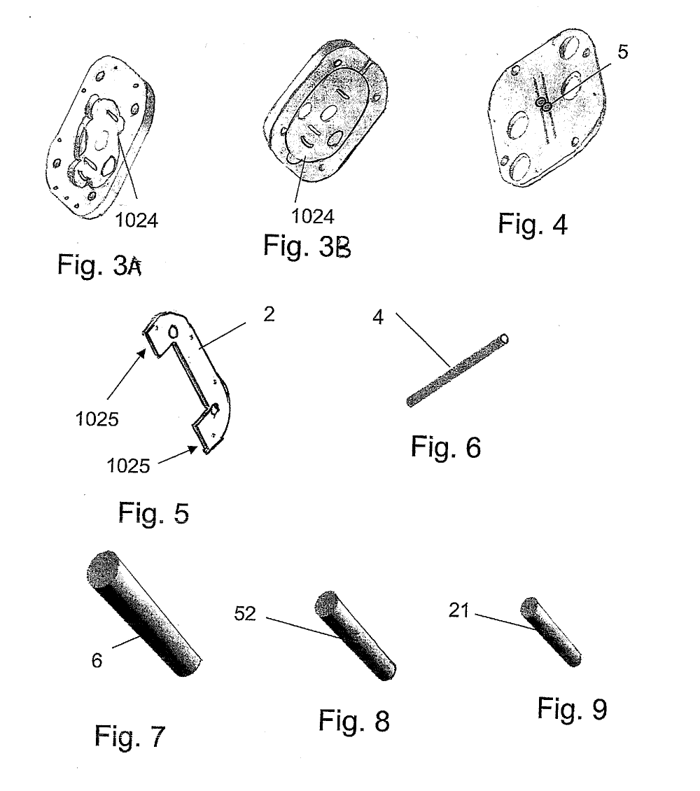

FIG. 3A and 3B—Frame-Main-Housing-Two parts are bolted together to form one main housing:
3A—Perspective view showing details on one side of the main housing.
3B—Perspective view showing details on the other side of the main housing.

FIG. 4—Frame-Cross-Rack-Holder-Guide perspective view.

FIG. 5—Frame-Telescopic-Guide perspective view.

FIG. 6—Shaft-Input perspective view.

FIG. 7—Shaft-Intermediate-Gear perspective view.

FIG. 8—Shaft-Power-Link perspective view.

FIG. 9—Shaft-Carrier perspective view.

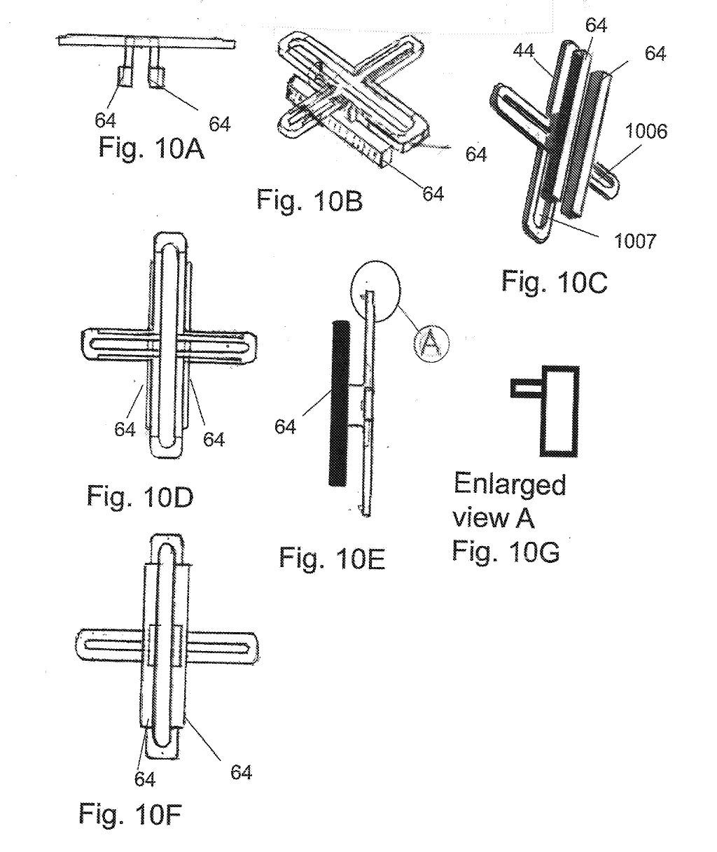

FIG. 10A through 10G—Cross Rack Assembly showing two perspective views and orthographic views showing details of the Input-Shaft-Slot 1012 and the Crank-Pin-Slot 1013, orientation of the racks and details of the prongs:
10A—Top view
10B—Perspective view 1
10C—Perspective view 2
10D—Front view
10E—Side view
10E—Rear view
10G—Enlarged view showing details of the prong.

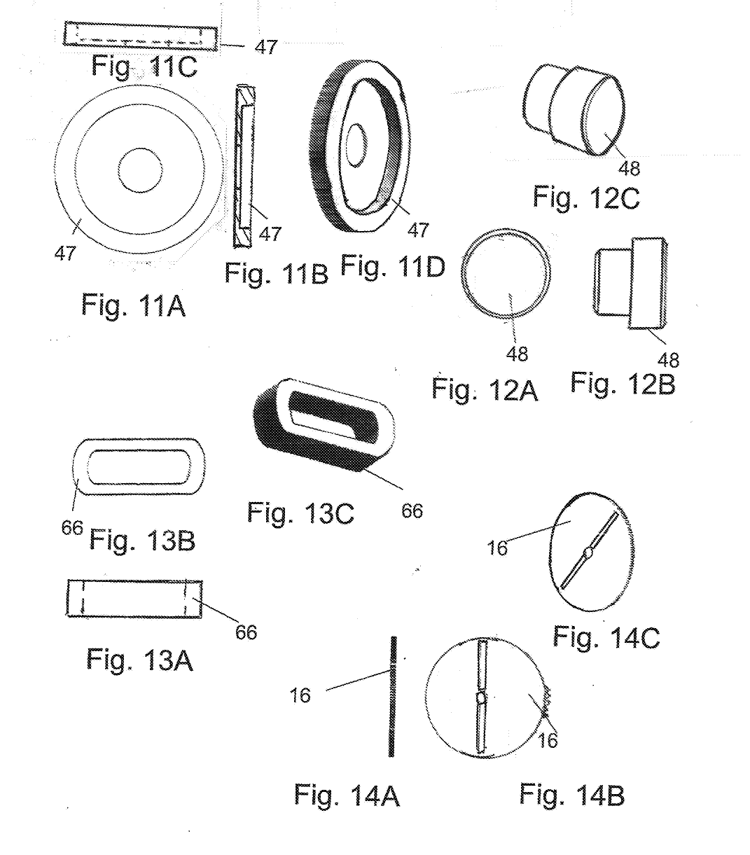

FIG. 11A through 11D—Pinion:
11A—Front view
11B—Side view
11C—Top view
11D—Perspective view

FIG. 12A through 12C—Shaft-Pinion:
12A—Front view
12B—Side view
12C—Perspective view

FIG. 13A through 13C—Retainer-Crank-Pin:
13A—Front view
13B—Side view
13C—Perspective view

FIG. 14A through 14C—Input-Disk:
14A—Front view
14B—Side view
14C—Perspective view

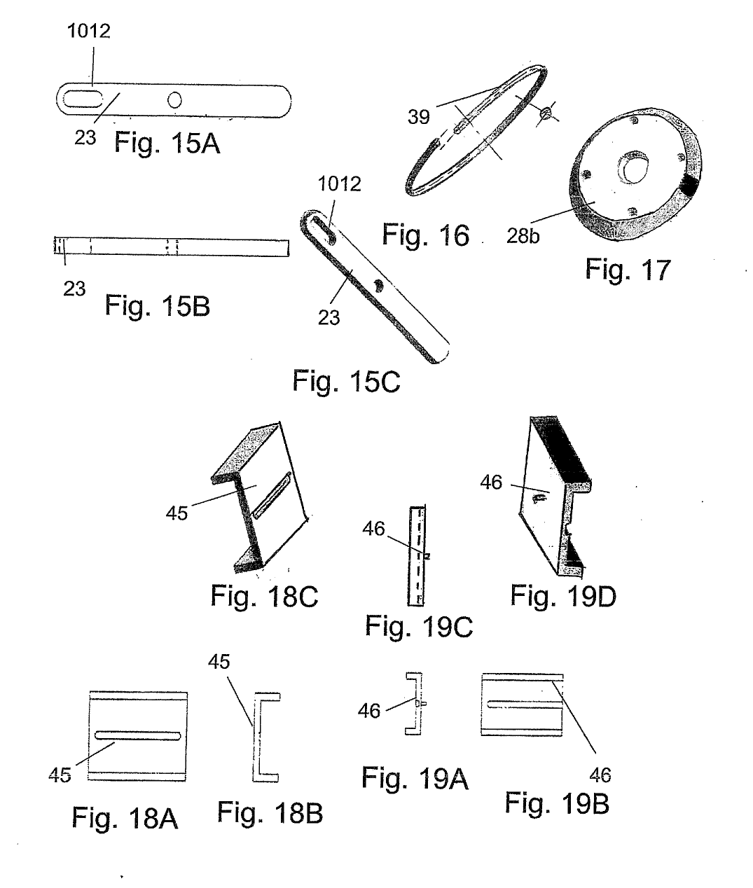

FIG. 15A through 15C—Gear-Changing-Lever-Planetary mechanism:
15A—Front view
15B—Top view
15C—Perspective view

FIG. 16—Compression-Spring Perspective view:

FIG. 17—Large-bevel-gear-Stationary-Differential-collar—Perspective view.

FIG. 18A through 18C—Sleeve-Primary-Telescopic:
18A—Front view
18B—Side view
18C—Perspective view

FIG. 19A through 19D—Sleeve-Secondary-Telescopic:
19A—Front view
19B—Side view
19C—Top view
19D—Perspective view

FIG. 20A through 20C—Ratio-Cam-Disk:
20A—Front view
20B—Top view
20C—Perspective view

FIG. 21A through 21C—Driven-Non-Circular-Gear:
21A—Top view
21B—Front view
21C—Perspective view

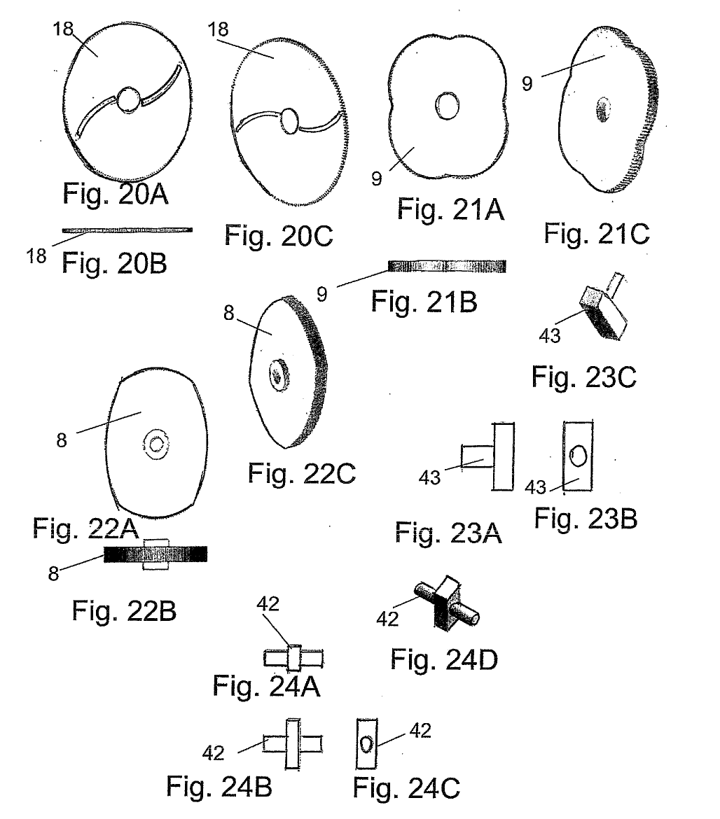

FIG. 22A through 22C—Driving-Non-Circular-Gear:
22A—Top view
22B—Front view
22C—Perspective view

FIG. 23A through 23C—Dummy-Crank-Pin:
23A—Top view
23B—Front view
23C—Perspective view

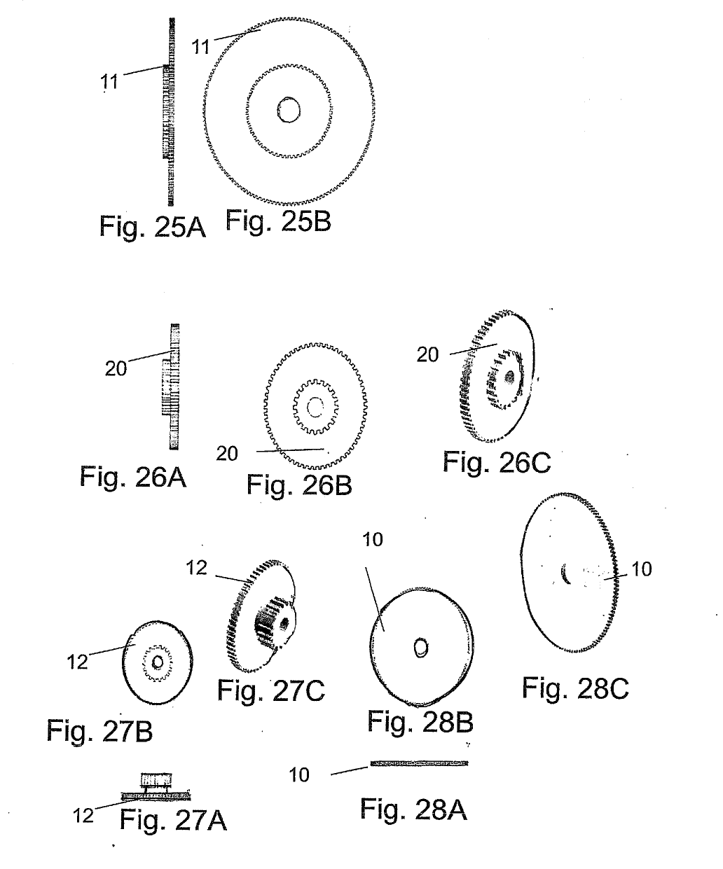

FIG. 24A through 24D—Crank-Pin:
24A—Top view
24B—Front view
24C—Side view
24D—Perspective view

FIG. 25A through 25C—Intermediate-Circular-Gears-C2-C3 which has two circular gears that are co-axial and rigidly connected:
25A—Side View
25B—Front View
25C—Perspective view

FIG. 26A through 26C—Carrier-Gear-C4a-C5a which has two circular gears that are co-axial and rigidly connected:
26A—Side View
26B—Front View
26C—Perspective view

FIG. 27A through 27C—Intermediate-Circular-Gears-C4-C5 which has two circular gears that are co-axial and rigidly connected:
27 A—Front view
27B—Top view
27C—Perspective view.

FIG. 28A through 28C—Intermediate-Circular-Gear-C1
28A—Front view
28B—Top view
28C—Perspective view

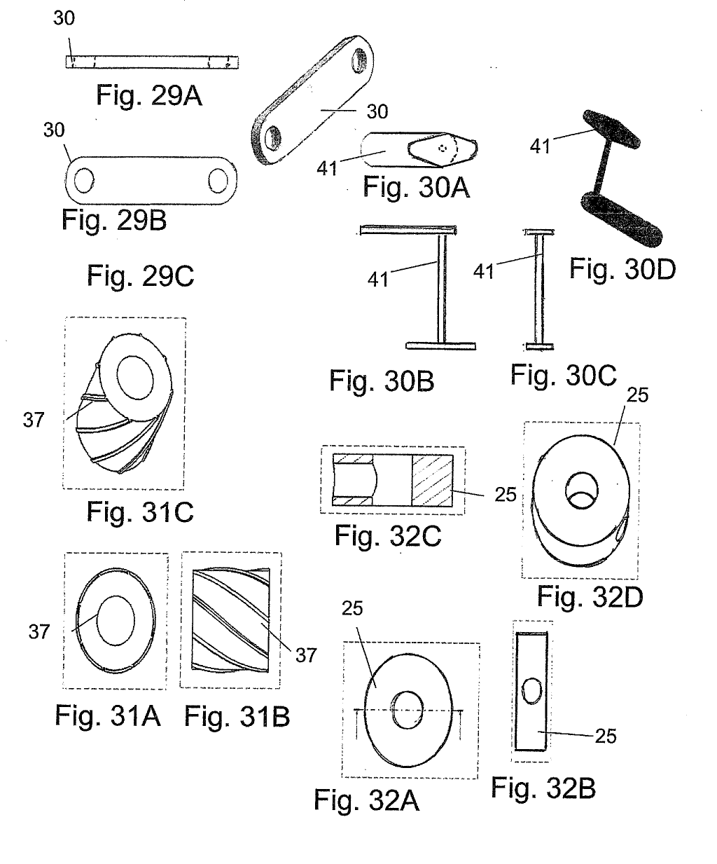

FIG. 29A through 29C—Spacer used to keep two axes separated by a specific distance:
29A—Top view
29B—Front view
29C—Perspective view

FIG. 30A through 30D—Gear-Changing-Lever-for-Spiral-flute-mechanism:
30A—Top view
30B—Front view
30C—Top view
30D—Perspective view

FIG. 31A through 31C—Spiral-Flute-Collar:
31A—Front view
31B—Side view
31C—Perspective view

FIG. 32A through 32D—Collar-Stationary-Differential:
32A—Front View
32B—Side view
32C—Section view
32D-Perspective view

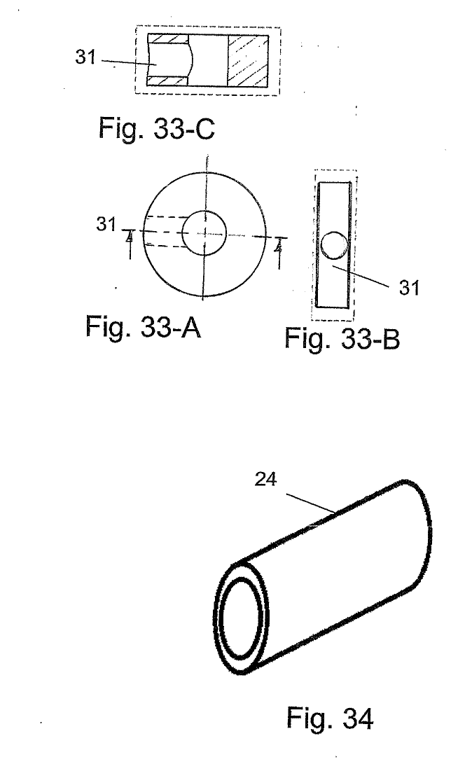

FIG. 33A through 33D Collar-Dynamic-Differential-:
33A—Front view
33B—Side view
33C—Section view
33D-Perspective view

FIG. 34—Sleeve-Input-Bevel perspective view:

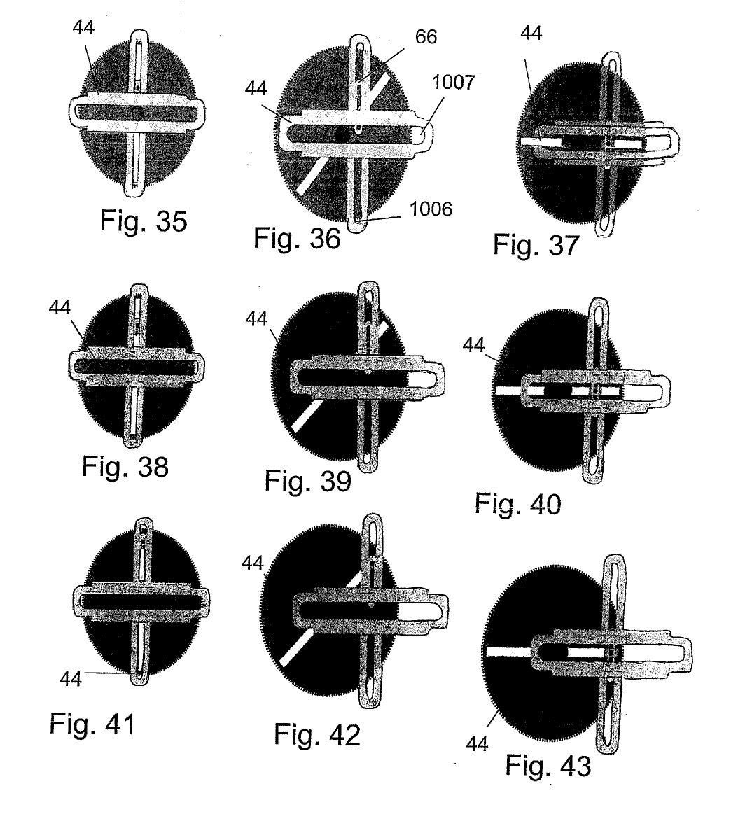

FIG. 35 thru 43—Views showing the movement/position on rack assembly, Crank-Pin as Input-Disk rotates: shown at various stages:

FIG. 35—Crank-Pin closer to the longitudinal axis and Input-Disk at Q°

FIG. 36—Crank-Pin closer to the longitudinal axis and Input-Disk at 45°

FIG. 37—Crank-Pin closer to the longitudinal axis and Input-Disk at 90°

FIG. 38—Crank-Pin at midpoint and Input-Disk at 0°

FIG. 39—Crank-Pin at midpoint and. Input-Disk at 45°

FIG. 40—Crank-Pin at midpoint and Input-Disk at 90°

FIG. 41—Crank-Pin farthest from the gear and Input-Disk at 0°

FIG. 42—Crank-Pin farthest from the gear and Input-Disk at 45°

FIG. 43—Crank-Pin farthest from the gear and Input-Disk at 90°

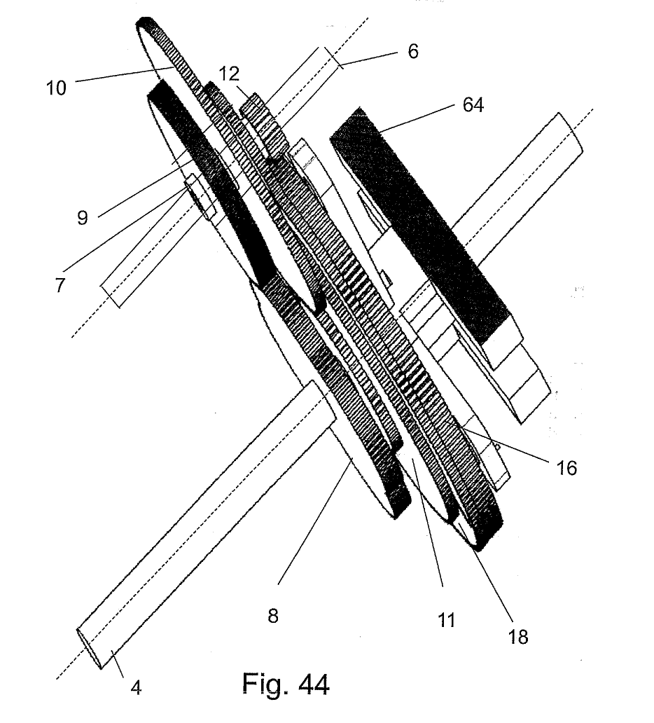

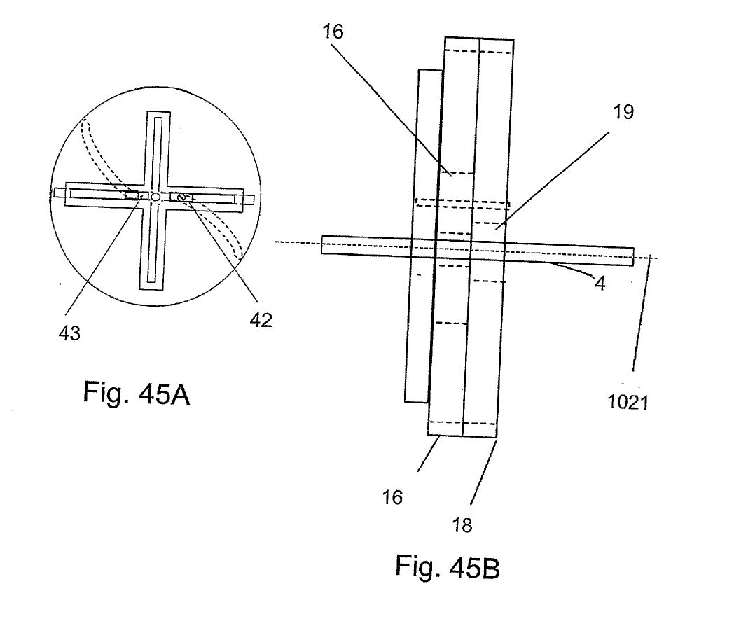

FIG. 44—Perspective view showing Input Modification. Details showing arrangements and gear train of Non-Circular-Gears and Intermediate-Gears from Input-Shaft to Input-Disk.

FIG. 45A through 45B—Ratio-Cam-Disk, Input-Disk and Crank-Pin showing operation behind how the cam alters the Crank-Pin location

FIG. 45A—Top View

FIG. 45B—Side View

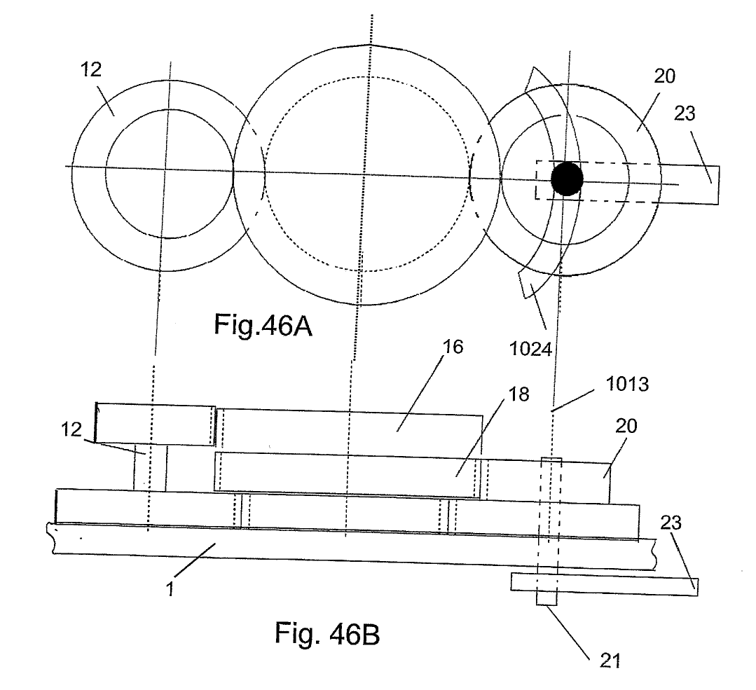

FIG. 46A and 46B—Views showing working of Planetary-Gear-Changing-Mechanism:

FIG. 46A—Top View

FIG. 46B—Side View

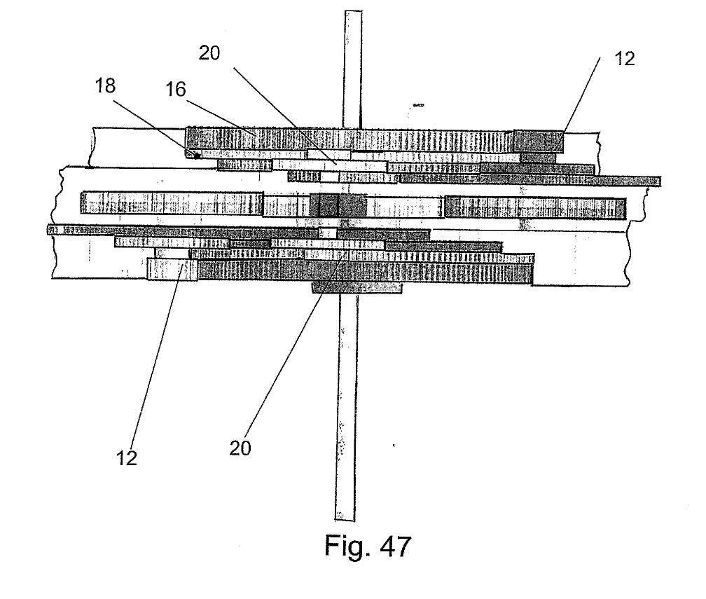

FIG. 47—Front view showing Planetary Gear Changing Mechanism. The Main Frame is made transparent for clarity.

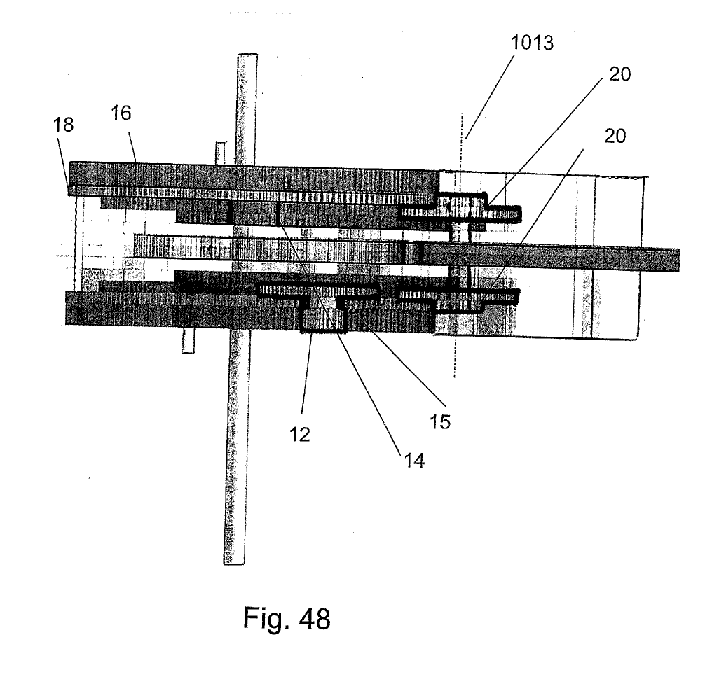

FIG. 48—Side View showing Planetary Gear Changing Mechanism. The Main Frame is made transparent for clarity.

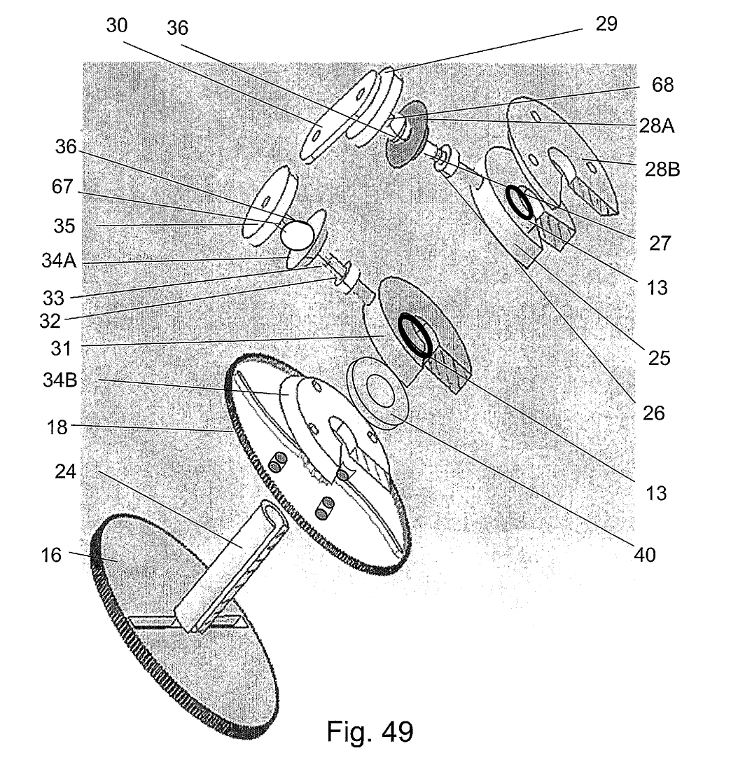

FIG. 49—Exploded view showing Differential-Mechanism, showing component arrangements and working (perspective view).

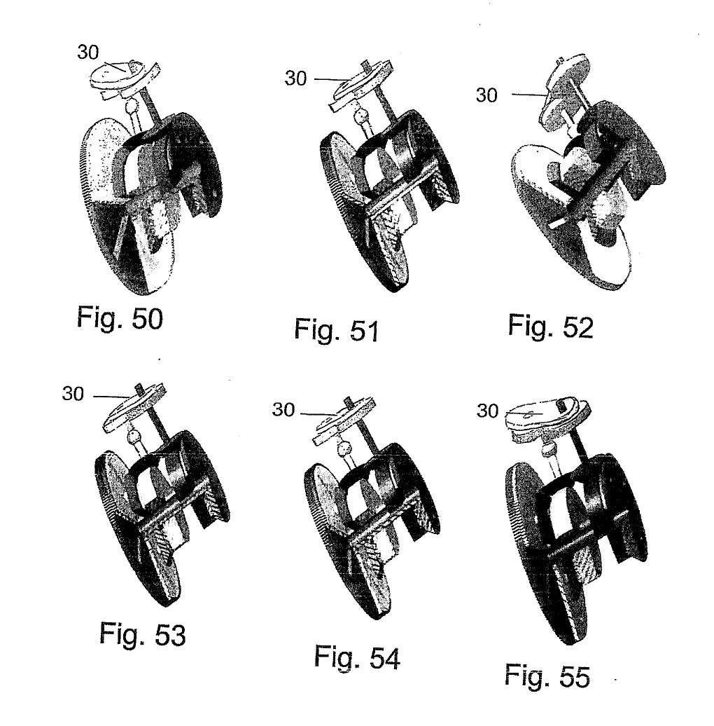

FIG. 50 thru 55—Views describing the ratio changing operation of the Differential-Mechanism at various stages—shown partially sectioned to explain the function and interior details:

FIG. 50—Differential-Mechanism (partially sectioned) view 1.

FIG. 51—Differential-Mechanism (partially sectioned) view 2.

FIG. 52—Differential-Mechanism (partially sectioned) view 3.

FIG. 53—Differential-Mechanism (partially sectioned) view 4.

FIG. 54—Differential-Mechanism (partially sectioned) view 5.

FIG. 55—Differential-Mechanism (partially sectioned) view 6.

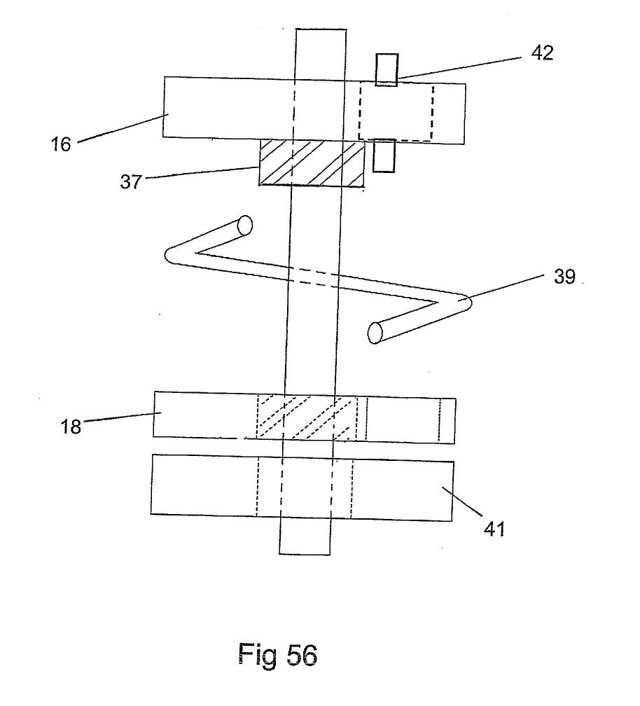

FIG. 56—Assembly showing working of gear changing mechanism—Spiral-Flute-Mechanism (exploded).

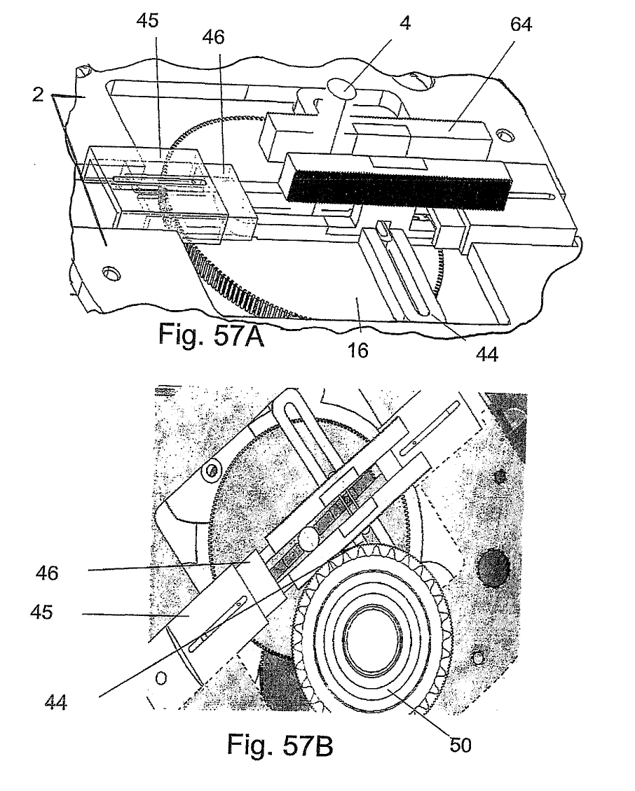

FIGS. 57A and 57B—Telescopic-Guide.

FIG. 57A—Isometric View

FIG. 57B—Top View

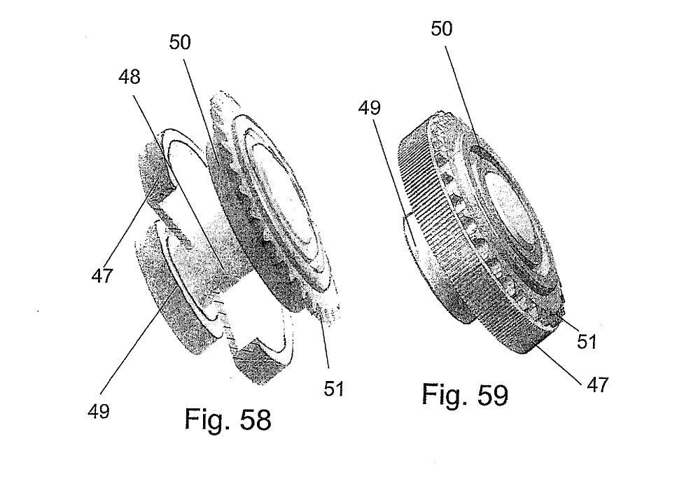

FIG. 58—Exploded view of One-Way-Bearing assembly (Pinion partially sectioned showing interior details).

FIG. 59—One-Way-Bearing assembly.

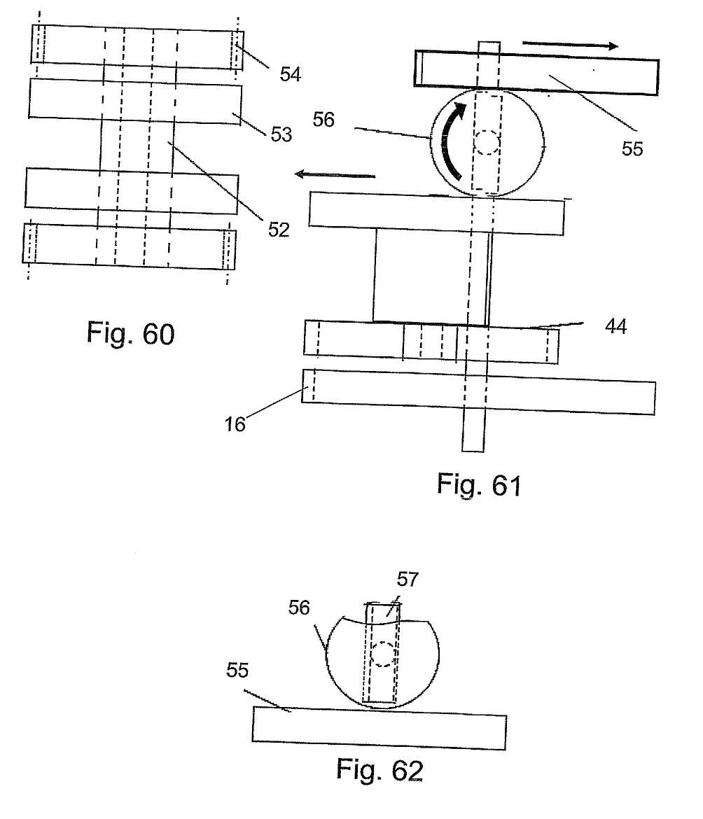

FIG. 60—Power-Link Assembly.

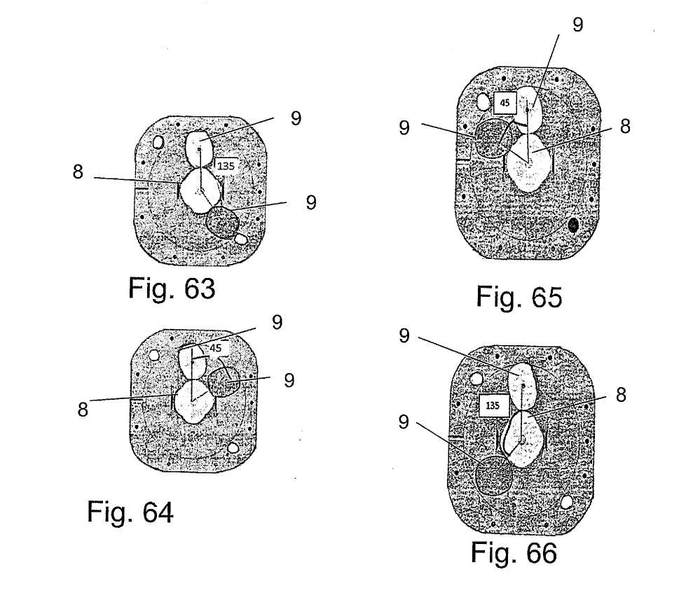

FIG. 61—Assembly showing concept of vibration cancelation.

FIG. 62—Vibration-Cancelation-Mechanism: sub-assembly.

FIG. 63 thru 66—Options of placement of Non-Circular-Gears, when a common Driving-Non-Circular-Gear is used with two Driven-Non-Circular-Gear.
FIG. 63 Non-Circular-Gear placed at 135°
FIG. 64 Non-Circular-Gear placed at 45°
FIG. 65 Non-Circular-Gear placed at (−) 45°
FIG. 66 Non-Circular-Gear placed at (−) 135°

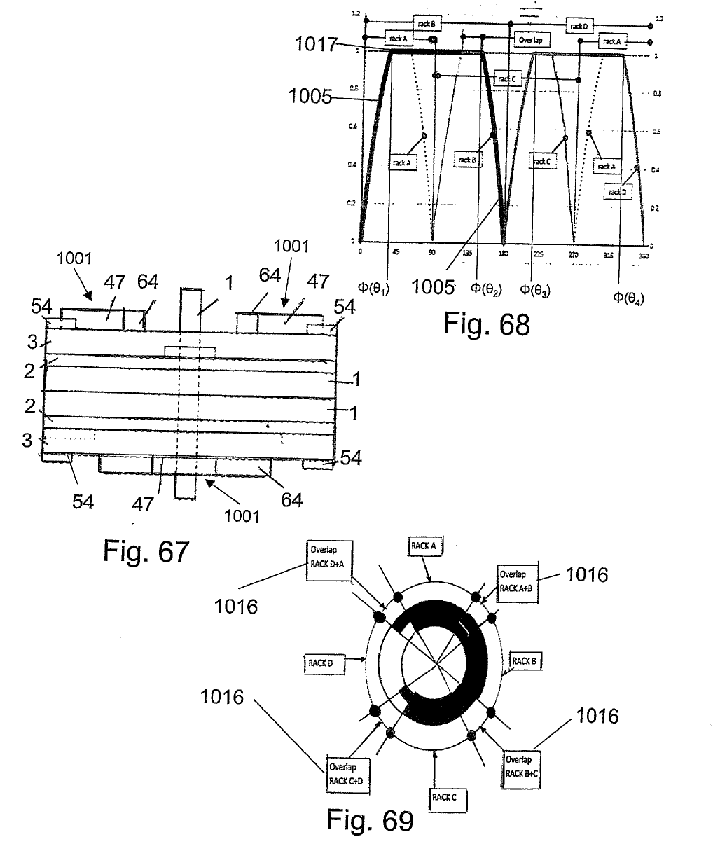

FIG. 67 thru 69—Details showing how constant and uniform output is achieved:
FIG. 67—Assembly orientation of individual Rectifier-Modules.
FIG. 68—Graph showing individual Rack-Movement-Function (output at each rack) for the non-linear option 1004 and combined total output showing constant and uniform output with overlaps. Horizontal axis shows the angle of rotation of the Driven-on-Circular-Gear 9. Vertical axis shows the Rack speed.
It is also showing the linear option 1003 for one of the Rectifier-Modules 1001 as well as angular position of the Driven-Non-Circular-Gear 9 where it switches from non-functional region 1005 to function region 1017.
FIG. 69—Graphical representation of output with overlaps and sequence of engagement for a complete cycle.

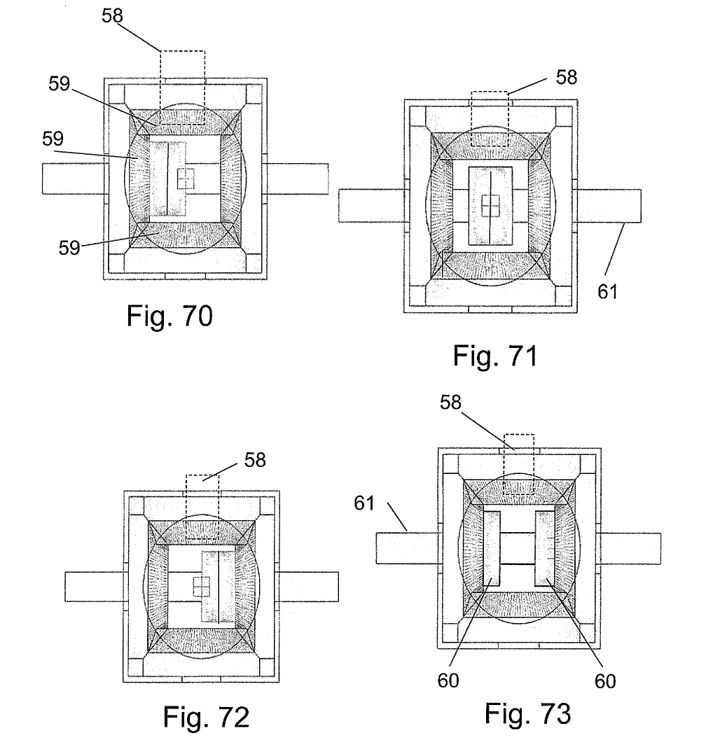

FIG. 70 thru 73—Miter/Bevel-gear assembly describing forward, reverse, neutral and park gears:
FIG. 70—Engagement of clutches for a Forward-gear.
FIG. 71—Engagement of clutches for a Reverse-gear.
FIG. 72—Engagement of clutches for a Neutral-gear.
FIG. 73—Engagement of clutches for “Park”.

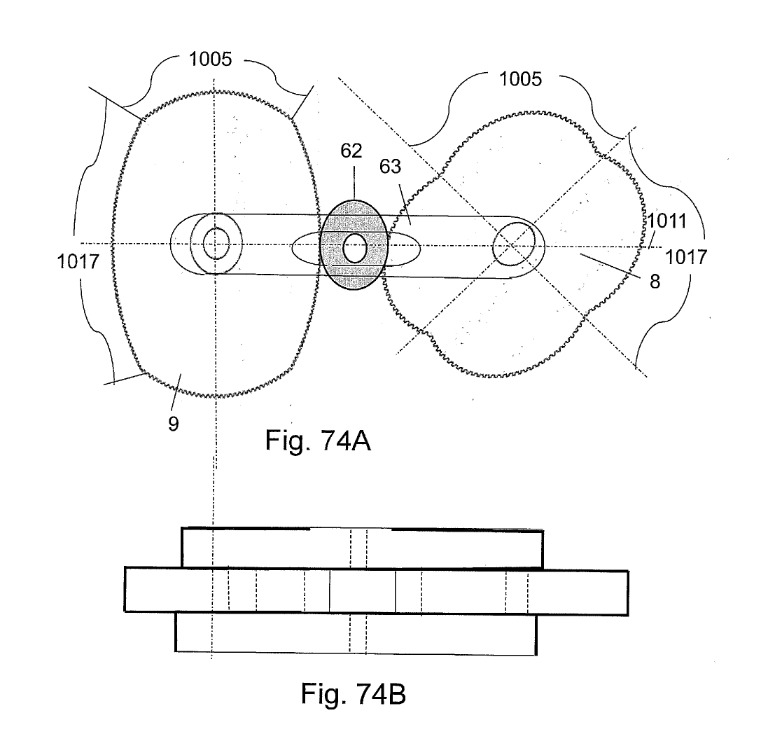

FIG. 74A and 74B—Concept of using of intermediate gear to eliminate multiple contacts between Non-Circular-Gears:
74A—top view
74B—front view

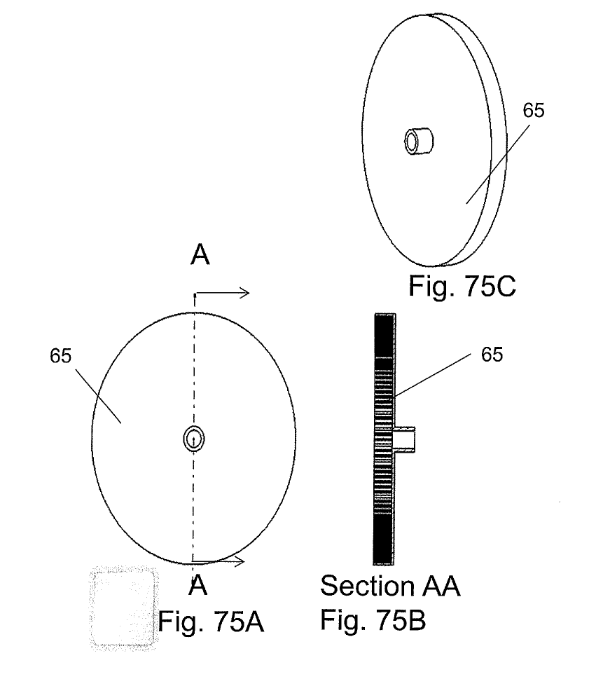

FIG. 75A through 75C—Co-axial output element:
75A—Front view
75B—Section side view
75C—Perspective view

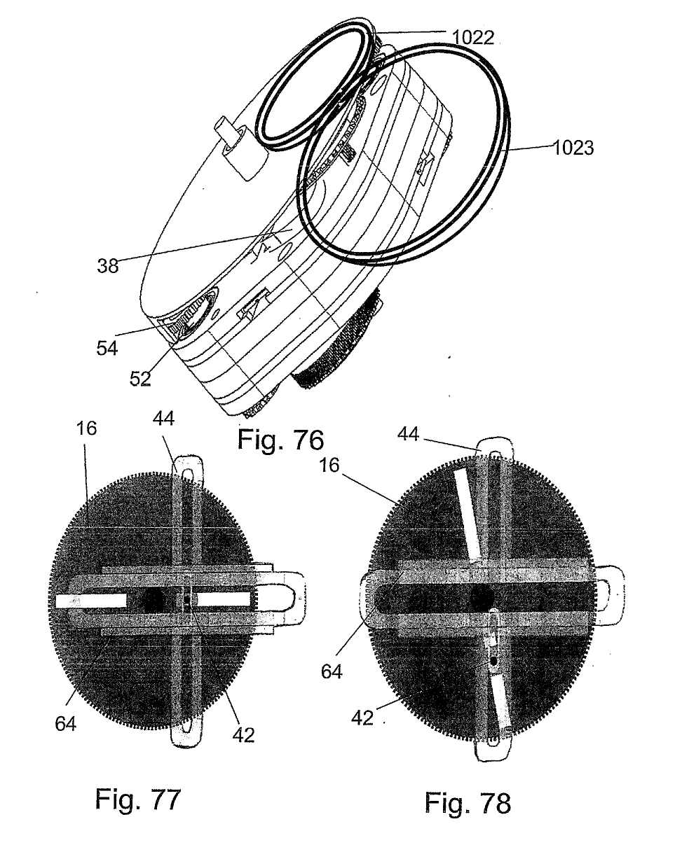

FIG. 76—Detail showing arrangement of co-axial output member in the assembly

FIG. 77—Crank-Pin and the Retainer-Crank-Pin when they are in the middle of input slot.

FIG. 78—Crank-Pin and the Crank-Pin retainer as it exits the input slot.

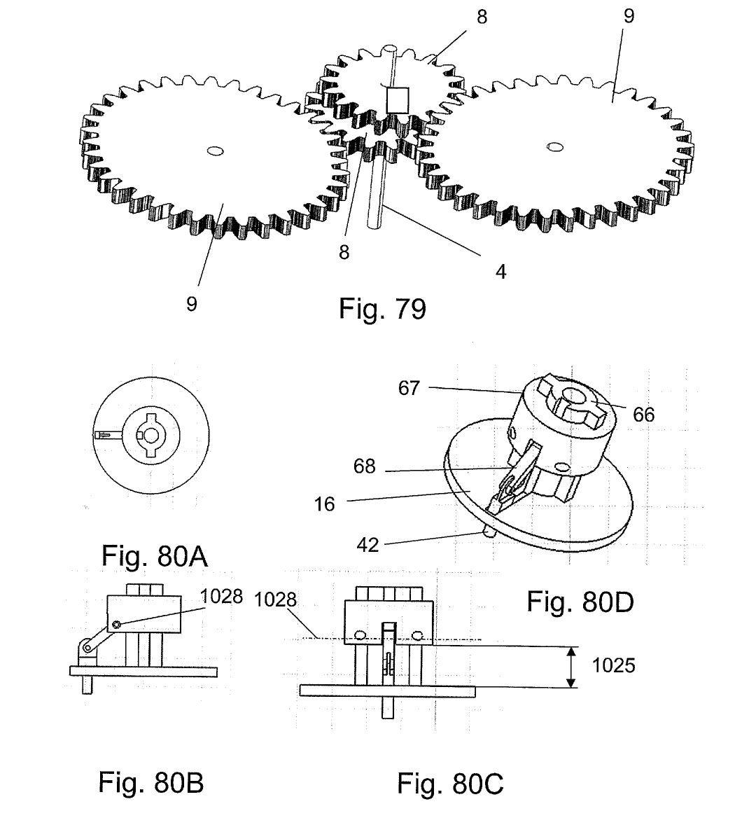

FIG. 79—Multiple driving and driven non-circular gears are stacked in 2 layers and the sum of all the active functional portions of the two non-circular gears pairs is □ 360°.

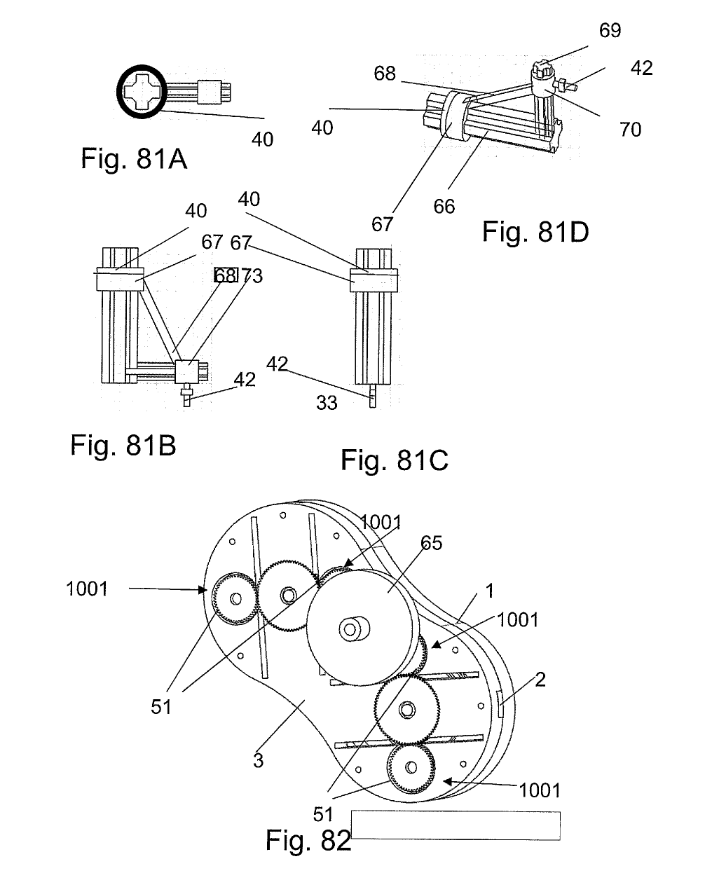

FIG. 80A through 80D—Sliding-Collar-Link-Gear-Changing-Mechanism
80A—Top View
80B—Left View
80C—Front View
80D—Isometric View

FIG. 81A through 81D—Optional Sliding-Collar-Link-Gear-Changing-Mechanism
81A—Top View
81B—Front View
81C—Right View
81D—Isometric View

FIG. 82—Alternate CVT assembly configuration—“Siamese” configuration showing all the 4 Rectifier-Modules 1001 are on the same side of the CVT.

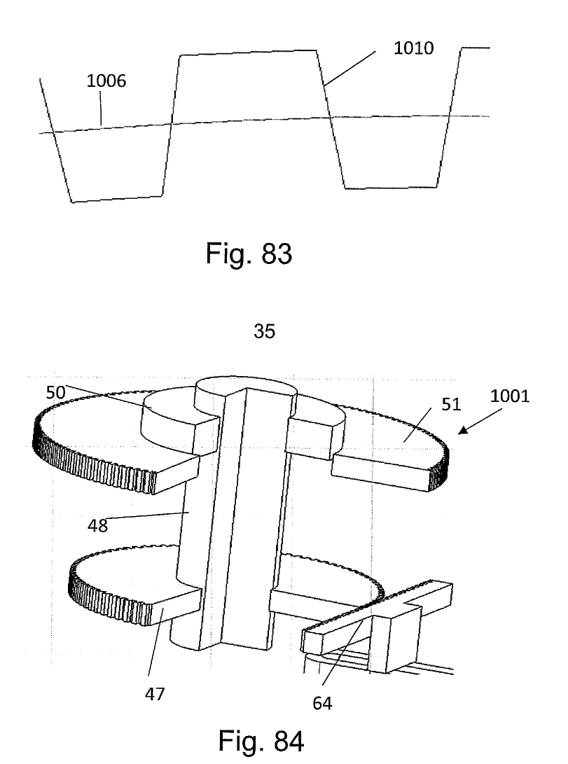

FIG. 83—A portion of the Pitch-Curve and Gear Teeth Profile of a gear

FIG. 84—Rectifier-Module where components are sectioned to show detail including Rack, Pinion, One-Way-Bearing, Shaft-Pinion and Output-Gear/Output-Sprocket

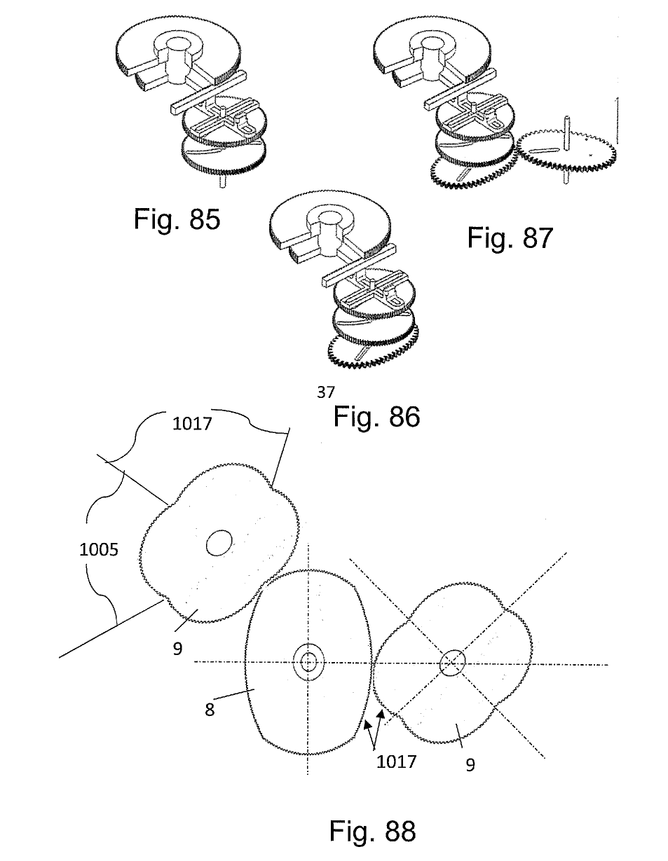

FIG. 85—Scotch-Yoke-Module

FIG. 86—Scotch-Yoke-Module with Driven-Non-Circular-Gear

FIG. 87—Angular-Velocity-Modifier-Module with Scotch-Yoke-Module

FIG. 88—Two Angular-Velocity-Modifier-Modules sharing the same Driving-Non-Circular-Gear

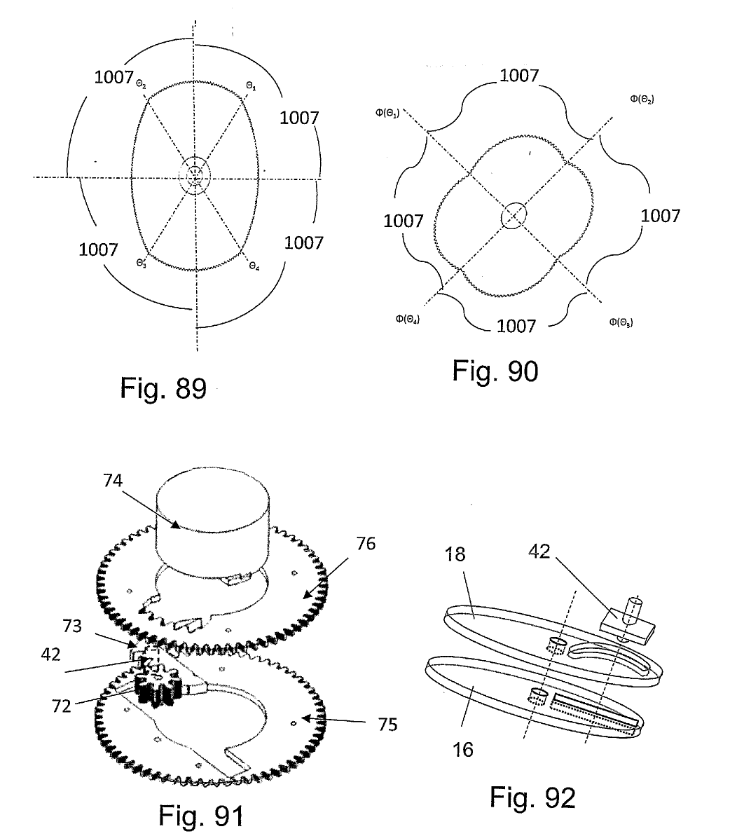

FIGS. 89 and 90—4 parts of each of the Non-Circular-Gears that can be derived by mirroring each other
89—Driving-Non-Circular-Gear
90—Driven-Non-Circular-Gear

FIG. 91—Alternative method of changing Crank-Pin position with Crank-Pin Axis on the Rack

FIG. 92—Alternative method of changing Crank-Pin position with Crank-Pin Axis at the intersection of the slots of the Input-Disk and Ratio-Cam-Disk

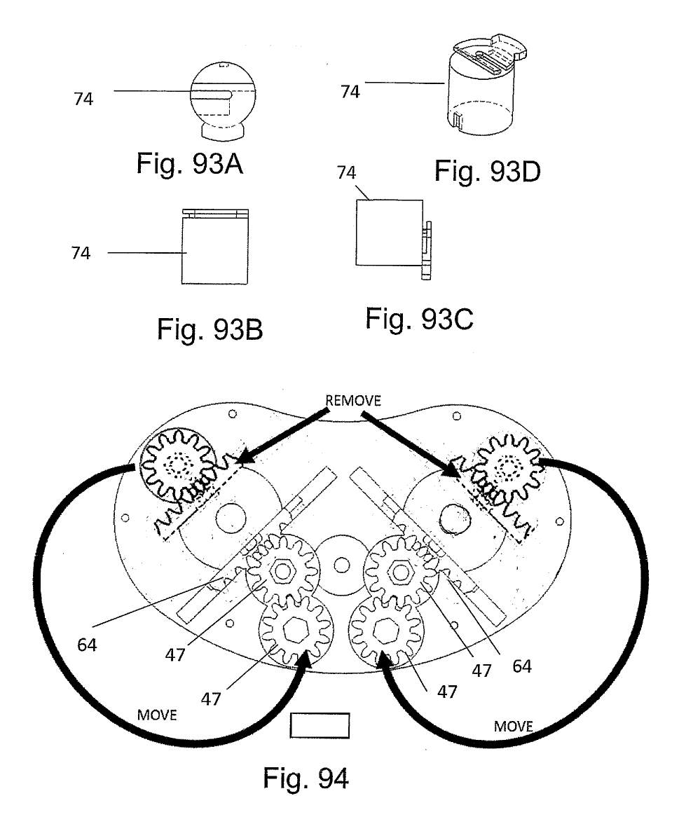

FIG. 93A through 93D—Notched Input Shaft
93A—Front View
93B—Top View
93C—Side View
93D—Isometric View

FIG. 94—Way to achieve two Rectifier-Modules using a common Rack and a Pinion

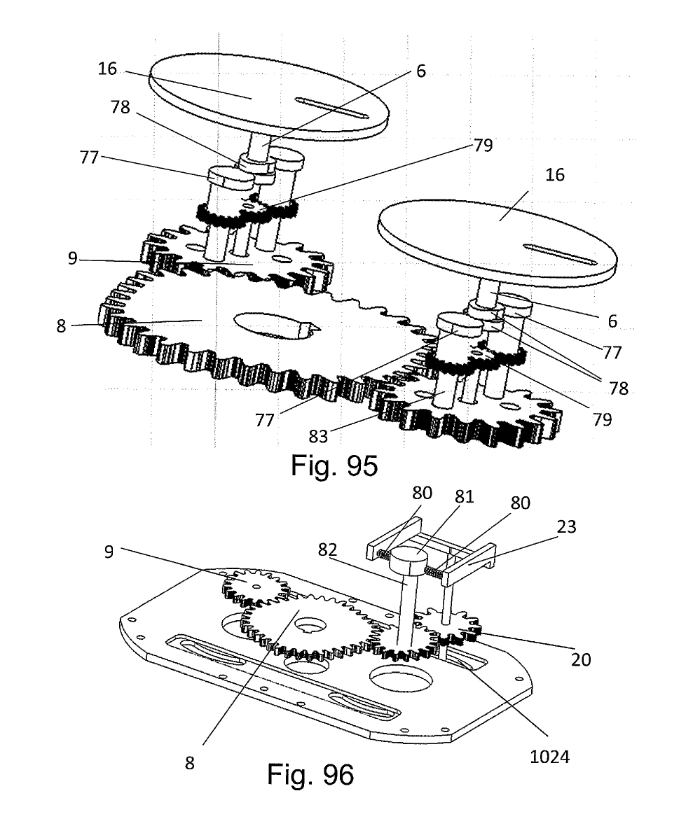

FIG. 95—Way to compensate for deviation in rack movement with Cams

FIG. 96—Way to assist with force required to move the crank pin to change input-to-output ratio

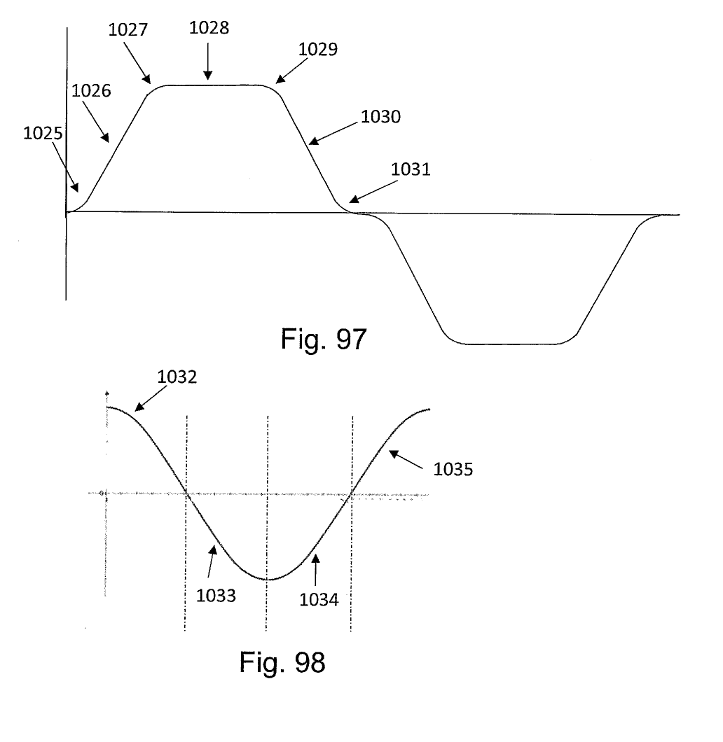

FIG. 97—Ideal rack velocity profile with smooth and gradual transitions. Angular displacement of the Driving-Non-Circular-Gear is on the X Axis. Rack Velocity is on the Y Axis.

FIG. 98—Total force on the Crank-Pins due to the load, when two Angular-Velocity-Modifier Modules are used. Angular displacement of the Driving-Non-Circular-Gear is on the X Axis. Total force on the Crank Pins is on the Y Axis.

### DETAILED DESCRIPTION OF THE INVENTION

### Summary of the Invention

To briefly describe this invention is an Infinitely Variable Transmission (IVT). Unlike existing CVT designs, this particular design does NOT depend on friction to transmit power. Most of the CVTs that exist today depend on friction to transmit power and therefore cannot be used where there is a need to transmit high power at low speed. Due to this advantage, it is possible to use this invention where high torque transmission is required. Co-axial input and output can be achieved with this layout.

### List of Components

1) Frame-Main-Housing

2) Frame-Cross-Rack-Holder-Guide

3) Frame-Telescopic-Guide

4) Shaft-Input

5) Bearing-Input-Shaft

6) Shaft-Intermediate-Gear

7) Bearing-Intermediate-Gear-Shaft

8) Driving-Non-Circular-Gear

9) Driven-Non-Circular-Gear

10) Intermediate-Circular-Gear-C1

11) Intermediate-Circular-Gears-C2-C3

12) Intermediate-Circular-Gears-C4-C5

13) Bearing-Collar

14) Bearing-Circular-Gear-C2-C3

15) Bearing-Circular-Gear-C4-C5

16) Input-Disk

17) Bearing-Input-Disk

18) Ratio-Cam-Disk

19) Bearing-Ratio-Cam-Disk

20) Intermediate-Circular-Gears-C4a-C5a

21) Shaft-Carrier

22) Bearing-Carrier-Shaft

23) Lever-Ratio-Changing-Planetary-Mechanism

24) Sleeve-Input-Disk

25) Collar-Stationary-Differential

26) Bearing-Stationary-Differential-Collar-Spur-Gear-Shaft

27) Shaft-Stationary-Differential-Collar-Spur-Gear

28) a) Small-Bevel-Gear-Stationary-Differential-Collar
b) Large-Bevel-Gear-Stationary-Differential-Collar

29) Spur-Gear-Stationary-Differential-Collar

30) Spacer-Spur-Gears

31) Collar-Dynamic-Differential

32) Bearing-Dynamic-Differential-Collar-Spur-Gear-Shaft

33) Shaft-Dynamic-Differential-Collar-Spur-Gear

34) a) Small-Bevel-Gear-Dynamic-Differential-Collar
b) Large-Bevel-Gear-Dynamic-Differential-Collar

35) Spur-Gear-Dynamic-Differential-Collar

36) Universal-Joint

37) Spiral-Fluted-Collar

38) Shaft-CVT-Output

39) Compression-Spring

40) Thrust-Bearing

41) Lever-Ratio-Changing-Spiral-Flute-Mechanism

42) Crank-Pin

43) Dummy-Crank-Pin

44) Cross-Rack-Holder

45) Sleeve-Primary-Telescopic

46) Sleeve-Secondary-Telescopic

47) Pinion

48) Shaft-Pinion

49) Bearing-Pinion

50) Computer-Controlled-Clutch/One-Way-Bearing/Ratchet-1\riechanism

51) Output-Gear/Output-Sprocket

52) Shaft-Power-Link

53) Bearing-Power-Link-Shaft

54) Power-Link-Sprocket/Power-Link-Gear

55) Dummy-Rack

56) Wheel-Vibration-Cancellation-JVIechanism

57) Collar-Wheel-Vibration-Cancellation-Mechanism

58) Input-Shaft-For-Miter/Bevel-Gears

59) Miter/Bevel-Gear

60) Clutch-Park/Neutral/Reverse

61) Miter/Bevel-Gear-Differential-Output-Shaft

62) Intermediate-Gear-Non-Circular-Gear-Connector

63) Guide-Intermediate-Gear-Non-Circular-Gear-Connector

64) Rack

65) Co-Axial-Output-Element-With-Internal-Gear/Planetary-Gear

66) Shaft-Auxiliary-Input

67) Sliding-Collar-Auxiliary-Input-Shaft

68) Link

69) Shaft-Crank-Pin

70) Collar-Crank-Pin-Shaft

71) Retainer-Crank-Pin

72) Spur-Gear-Crank-Pin-Rack

73) Rack-Crank-Pin

74) Shaft-Notched-Input

75) Disk-Input-Modified

76) Ratio-Cam-Disk-Modified

77) Cam-Gear

78) Cam-Input-Shaft

79) Stationary Sun Gear

80) Spring-Force-Compensation

81) Cam-Spring

82) Shaft-Cam

The working of this CVT can be described by the following simple sequential operations.
a) A Crank-Pin 42 (FIG. 23), revolves around the longitudinal axis 1021 of an Input-Disk 16 (FIG. 14) or a Shaft-Input 4 (FIG. 6) or a Shaft-Auxiliary-Input 66 at an offset distance 1025 as shown in FIG. 80, and this offset distance can be altered. The offset distance ranges from zero to a non-zero value. The concept described in this operation exists in another patent application US 20100199805. However, here an entirely different approach is adapted on how this concept is used, how the offset is altered etc. in a much simpler, and in a compact envelop.
b) This offset Crank-Pin 42 is caged in
   1) the Input-Disk 16 or alternatively in a Collar-Crank-Pin-Shaft 70 that slides on a Shaft-Crank-Pin 69, and
   2) a slot of a Cross-Rack-Holder 44 (FIG. 10).

The Cross-Rack-Holder 44 is restricted such that it can move only in the direction that is normal to its slot. A Rack 64 is fastened to the Cross-Rack-Holder 44, such that the Rack 64 is parallel to the Cross-Rack-Holder's 44 direction of movement. In the alternative construction, the Shaft-Crank-Pin 69 is orthogonal to the Shaft-Input 4. The revolution of the Crank-Pin 42 about the longitudinal axis 1021 of Input-Disk 16 is translated to pure linear back and forth movement or reciprocating movement of the Rack 64. This mechanism is commonly known as “Scotch-Yoke-Mechanism” in the industry. The distance of this linear back and forth movement (stroke) is directly proportional to the radial distance of the Crank-Pin 42 from the longitudinal axis 1021 of the Input-Disk 16. Since the work done is constant, which is a product of force applied multiplied by the distance traveled (F*stroke), for a smaller stroke, the force applied is greater and for a longer stroke, the force applied is smaller.
c) The Rack 64 is linked to a Pinion (FIG. 11) converting this linear movement of the Rack 64 to rocking oscillation of the Pinion 47.
d) This rocking oscillation is converted to a unidirectional rotation, using a Computer-Controlled-Clutch/One-Way-Bearing/Ratchet-Mechanism 50.

One main purpose of this invention is to achieve a CONSTANT AND UNIFORM output angular velocity when the input angular velocity is constant and uniform. However, using the steps described above, this is NOT achieved, as the output is sinusoidal. By modifying the rate of change of angular displacement of the Input-Disk 16, a uniform steady output can be achieved. By using a set of Non-Circular-Gears, the Driving-Non-Circular-Gear 8 (FIG. 22) and the Driven-Non-Circular-Gear 9 (FIG. 21), the instantaneous rate of change of angular displacement at the Input-Disk 16 can be altered. The output from the Driven-Non-Circular-Gear 9 is then transferred to the Input-Disk 16 via some Intermediate-Circular-Gears.

The design construction is grouped in to modules/mechanism for easier understanding: Detailed description of Assembly, Sub-assembly of components/Modules and their functions:
a) Angular-Velocity-Modifier-Module (FIG. 87): The main purpose of this module is to change the uniform rate of power input to a reciprocal of sinusoidal output. This is to reverse the effect of the sinusoidal output in a scotch yoke mechanism. This module comprises of:
1) Driving-Non-Circular-Gear 8,
   2) Driven-Non-Circular-Gear 9 and
3) Shaft-Input 4
The Driving-Non-Circular-Gear 8 is mounted on the Shaft-Input 4. This drives the Driven-Non-Circular-Gear 9.
b) Scotch-Yoke-Module (FIG. 86): The main purpose of this module is to convert circular motion to a reciprocating motion. The output is sinusoidal for a steady, uniform input. This output is converted to a steady, uniform output using Angular-Velocity-Modifier-Module.
This Scotch-Yoke-Module comprises of:
   1) Input-Disk 16,
   2) Cross-Rack-Holder 44, and
3) Crank-Pin 42

The Input-Disk 16 has a radial slot, with optionally geared profile 1010 on its perimeter. The

Ratio-Cam-Disk (FIG. 20) has non-radial slot from center to the periphery with a minimum wall thickness. Optionally the Ratio-Cam-Disk 18 also has a geared profile 1010 on its perimeter with identical pitch-curve as in the Input-Disk 16. The Input-Disk 16 and the Ratio-Cam-Disk 18 are placed adjacent to each other. They are placed co-axial with respect to their longitudinal axes. The Cross-Rack-Holder 44 has a slot namely “Crank-Pin-Slot” 1013. It also has an extension on either side of the slot at the middle of the slot. This extension is normal to the Crank-Pin-Slot 1013. This Cross-Rack-Holder 44 optionally has another slot on this extension namely “Input-Shaft-Slot” 1012. This slot is normal to the “Crank-Pin-Slot” 1013. The purpose of this slot is to allow the option of Shaft-Input 4 to pass through. The Cross-Rack-Holder 44, is placed on the other side of the Input-Disk 16 sandwiching the Input-Disk 16 between the Cross-Rack-Holder 44 and a Ratio-Changing-Mechanism, which is described in subsequent paragraphs. The Crank-Pin 42 passes through the slots of Ratio-Changing-Mechanism, Input-Disk 16, and Cross-Rack-Holder 44
c) Rectifier-Module: The main purpose of this module is a mechanical equivalent to a diode in an electrical circuit. It allows power transfer to one specific direction.
   1) Rack 64,
   2) Pinion 47,
   3) Shaft-Pinion 48,
   4) Computer-Controlled-Clutch/One-Way-Bearing/Ratchet-Mechanism 50 and
   5) Output-Gear/Output-Sprocket 51
   The Rack 64 is attached to the Cross-Rack-holder 44 normal to the Crank-Pin-Slot 1013 and paired with the Pinion 47. The Pinion 47 is mounted on a Shaft-Pinion 48. The Computer-Controlled-Clutch/One-Way-Bearing I Ratchet-Mechanism 50 is mounted on the Shaft-Pinion 48. The Output-Gear/Output-Sprocket 51 is mounted on the OD of the One-Way-Bearing 50.
   An alternative way to achieve two Rectifier-Module using a common Rack 64 a Pinion 47 and a Shaft-Pinion 48 is to use two Output-Gear/Output-sprocket 51 on the common Shaft-Pinion 48 with the Computer-Controlled-Clutch/One-Way-Bearing/Ratchet-Mechanism 50 to effective in opposite directions.
   It is possible to use a common Rack 64 for two Rectifier-Modules which are phased 180° apart, by directly pairing one Pinion 47 that is paired with the Rack 64 in one Rectifier-Module with another Pinion 47 of another Rectifier-Module which is phased at 180° and thereby eliminate the need for the additional Rack 64 in one of the two Rectifier-Modules. (FIG. 94)
d) Gear-Changing-Mechanisms: One of four different mechanisms are used on each Scotch-Yoke-Module here namely
   1) Planetary-Mechanism,
   2) Spiral-Flute-Mechanism,
   3) Differential-Mechanism, and
   4) Link Mechanism
   The Planetary-Mechanism, Spiral-Flute-Mechanism and the Differential-Mechanism mainly use the relative rotation of input-Disk 16 and the Ratio-Cam-Disk 18 where the relative rotation is controlled by a synchronous-control-mechanism. This relative rotation is used by a Crank-Pin-Displacement-Mechanism to achieve translation of the Crank-Pin 42 radially. Link-Mechanism uses the axial motion of a non-rotating disk and an axially stationary rotating disk. This relative motion is used by a suitable mechanism to achieve translation of the Crank-Pin 42 radially. The construction details and the working of these mechanisms are discussed in detail in the subsequent paragraphs.
   Operating principle of the Gear-Changing-Mechanisms (methods to change ratio):
1) Planetary-Mechanism,
   A set of Intermediate-Circular-Gears-C4a-C5a 20 (FIG. 26), where the gears C4a and C4b are axially connected, is mounted on a common Shaft-Carrier 21 (FIG. 9). C4a has identical Pitch-Curve to the circular gear's C4 Pitch-Curve and C5a has identical Pitch-Curve to the circular gear's C5 Pitch-Curve. The movement of this longitudinal axis of the Intermediate-Circular-Gears C4a-C5a 20 is restricted to a circular slot/path namely Main-Housing-Slot 1024, which is at a constant distance from the longitudinal axes of the Input-Disk 16 and the Ratio-Cam-Disk 18, while the longitudinal axis of Intermediate-Circular-Gears-C4-C5 12 is stationary. The gear C4a is radially connected to gear C3 and the gear C5a is radially connected to the Ratio-Cam-Disk 18. The gear C4 is radially connected to gear C3 and the gear C5 is radially connected to the Input-Disk 16. A Lever-Ratio-Changing-Planetary-Mechanism 23 (FIG. 37) pivoted on the frame enables the location of the Shaft-Carrier 21 to move along the Main-Housing-Slot. While the location is being displaced, there is a relative angular displacement between the Input-Disk 16 and the Ratio-Cam-Disk 18.
2) Spiral-Flute-Mechanism:
   A Spiral-Fluted-Collar (FIG. 38) with twisted profile is axially attached to the Input-Disk 16. A slot matching the twisted profile of the Spiral-Fluted-Collar 37 is broached on the Ratio-Cam-Disk 18 and placed co-axial to the Input-Disk 16. When the distance between the Ratio-Cam-Disk 18 and the Input-Disk 16 remain unchanged, the Input-Disk 16 and the Ratio-Cam-Disk 18 spin synchronized. While the distance between the Input-Disk 16 and the Ratio-Cam-Disk 18 is being altered, the relative angular velocity between the Input-Disk 16 and the Ratio-Cam-Disk 18 changes as the Ratio-Cam-Disk 18 is altered making Ratio-Cam-Disk 18 to rotate with respect to the Input-Disk 16. This axial translation is achieved with a Lever-Ratio-Changing-Spiral-Flute-Mechanism 41 that pushes a Thrust-Bearing 40 attached to the Ratio-Cain-Disk 18 towards the Input-Disk 16. This is sprung back with a Compression-Spring 39 (FIG. 56) placed between the Input-Disk 16 and the Ratio-Cam-Disk 18.
3) Differential-Mechanism:
   A Large-Bevel-Gear-Stationary-Differential-Collar 28b is axially attached to the Input-Disk 16 via a Sleeve-Input-Disk 24 to bevel (FIG. 32). A Collar-Stationary-Differential 25 (FIG. 32), which is co-axially spaced to the Large-Bevel-Gear-Stationary-Differential-Collar 28b, by a Thrust-Bearing 40 is free to spin independently with respect to the Large-Bevel-Gear-Stationary-Differential-Collar 28b. The Collar-Stationary-Differential 25 is restricted to move axially with respect to the Large-Bevel-Gear-Stationary-Differential-Collar 28b. A, free to spin Shaft-Stationary-Differential-Collar-Spur-Gear 27 is placed normal to the longitudinal axis of the Collar-Stationary-Differential 25 in a Bearing-Stationary-Differential-Collar-Spur-Gear-Shaft 26 placed in the Collar-Stationary-Differential 25. A Small-Bevel-Gear-Stationary-Differential-Collar-28a and a Spur-Gear-Stationary-Differential-Collar 29 is axially and rigidly attached to the Shaft-Stationary-Differential-Collar-Spur-Gear 27 and the Small-Bevel-Gear- Stationary-Differential-Collar 28a is paired with the Large-Bevel-Gear-Stationary-Differential-Collar 28b.
Similarly,
A Large-Bevel-Gear-Dynamic-Differential-Collar 34b (FIG. 17) is co-axially placed parallel to the Ratio-Cam-Disk 18 such that they spin synchronized but allowing displacement between them along the longitudinal axis. A Collar-Dynamic-Differential 31 (FIG. 33) which is co-axially placed to the Large-Bevel-Gear-Dynamic-Differential-Collar 34b spaced by a Thrust-Bearing 40 is free to spin independently with respect to the Large-Bevel-Gear-Dynamic-Differential-Collar 34b. The Collar-Dynamic-Differential 31 is restricted to move axially with respect to the Large-Bevel-Gear-Dynamic-Differential-Collar 34b. A, free to spin Shaft-Dynamic-Differential-Collar-Spur-Gear 33 with a Universal-Joint 36 placed in its longitudinal axis is placed normal to the longitudinal axis of the Collar-Dynamic-Differential 31 in a Bearing-Dynamic-Differential-Collar-Spur-Gear-Shaft 32 placed in the Collar-Dynamic-Differential 31. A Small-Bevel-Gear-Dynamic-Differential-Collar 34a and a Spur-Gear-Dynamic-Differential-Collar 35 is axially and rigidly attached to the Shaft-Dynamic-Differential-Collar-Spur-Gear 33 and the Small-Bevel-Gear-Dynamic-Differential-Collar 34a is paired with the Large-Bevel-Gear-Dynamic-Differential-Collar 34b . The Universal-Joint 36 is common to the Shaft-Dynamic-Differential-Collar-Spur-Gear 33 and the Small-Bevel-Gear-Dynamic-Differential-Collar 34a, allowing a small mismatch.
A Spacer-Spur-Gears 30 keeps the two spur-gears in contact. The Spacer-Spur-Gears 30 (FIG. 29) is free to move axially with respect to Shaft-Dynamic-Differential-Collar-Spur-Gear 33.
Here the Collar-Stationary-Differential 25 and the Collar-Dynamic-Differential 31 are identical and interchangeable.

By this arrangement the dynamic flow train is as described below
I. The Large-Bevel-Gear-Stationary-Differential-Collar 28b spins Small-Bevel-Gear-Stationary-Differential-Collar 28a.
II. The Small-Bevel-Gear-Stationary-Differential-Collar 28a spins the Shaft-Stationary-Differential-Collar-Spur-Gear 27.
III. The Shaft-Stationary-Differential-Collar-Spur-Gear 27 spins the Spur-Gear-Stationary-Differential-Collar 29.
IV. The Spur-Gear-Stationary-Differential-Collar 29 spins Spur-Gear-Dynamic-Differential-Collar 35.
V. The Spur-Gear-Dynamic-Differential-Collar 35 spins Shaft-Dynamic-Differential-Collar-Spur-Gear 33.
VI. The Shaft-Dynamic-Differential-Collar-Spur-Gear 33 thru the Universal-Joint 36 spins the Small-Bevel-Gear-Dynamic-Differential-Collar 34a.
VII. The Small-Bevel-Gear-Dynamic-Differential-Collar 34a spins the Large-Bevel-Gear-Dynamic-Differential-Collar 34b.
VIII. The Large-Bevel-Gear-Dynamic-Differential-Collar 34b spins the Ratio-Cam-Disk 18. Since the two large bevel-gears, the two small bevel-gears, and the spur-gears are identical and same size respectively, when the Collar-Dynamic-Differential 31 is stationary, the angular velocity of the Ratio-Cam-Disk 18 is synchronized with the Input-Disk 16. While the Collar-Dynamic-Differential 31 is being rotated with respect to the Collar-Stationary-Differential 25, there will be a relative angular displacement between the Input-Disk 16 and the Ratio-Cam-Disk 18.
4) Link Mechanism:
   The Shaft-Auxiliary-Input 66 has a cross section with a circular hole in the middle and a non-circular shape for the exterior perimeter. This is paired with a Sliding-Collar-Auxiliary-Shaft 67 with a matching orifice, which is co-axially placed allowing axial movement while restricting rotational motion with respect to each other. A Thrust-Bearing 40 is co-axially placed in contact with one end of the Sliding-Collar-Auxiliary-Shaft 67 and the Sliding-Collar-Auxiliary-Shaft 67 has a pivot 1028 on the other end. One end of a Link 68 is attached to the pivot 1028 and the other end of the Link 68 is either attached to the Crank-Pin 42, as shown in (FIG. 80) or to the Collar-Crank-Pin-Shaft 70, as shown in (FIG. 81) as appropriate. An axial displacement of the Sliding-Collar-Auxiliary-Shaft 67 will cause a radial displacement of the Crank-Pin 42 thru the Link 68. This axial translation is achieved with a Lever-Ratio-Changing-Spiral-Flute-Mechanism 41 that pushes the Thrust-Bearing 40 attached to the Sliding-Collar-Auxiliary-Shaft 67. This is sprung back with a Compression-Spring 39 placed between Input-Disk 16 and the Sliding-Collar-Auxiliary-Input-Shaft 67. When this link mechanism is used, the need to have geared tooth profile 1010 on the perimeter of the Input-Disk 16 is eliminated (FIG. 80D). Also, when this link mechanism is used the Driven-Non-Circular-Gear 9 can also function as the Input-Disk 16 when a radial slot is added to the Driven-Non-Circular-Gear 9, thereby eliminating the need for a separate Input-Disk 16.

A Cross-Rack-Holder 44, Input-Disk 16, Driven-Non-Circular-Gear 9, Intermediate-Circular-Gears 12 and 20, Crank-Pin 42, Ratio-Cam-Disk 18 , and a Ratio-Changing-Mechanism is used for Two Rectifier-Modules 1001 are used in one Scotch-Yoke-Module (FIG. 86) and two Scotch-Yoke-Modules are used in this assembly configuration.

Two Racks 64 are placed on the Cross-Rack-Holder 44 with a phase shift of 180°.

Another identical assembly of Scotch-Yoke-Modules (FIG. 86) with two Rectifier-Modules 1001 is duplicated and placed such that the second assembly of Scotch-Yoke -Modules (FIG. 86) with two Rectifier-Modules 1001 is a lateral inversion of the first assembly of Scotch-Yoke-Modules with two Rectifier-Modules 1001 and rotated by 90°. The selection of the plane of lateral inversion creates multiple assembly configurations such as sequential assembly (FIG. 1) or Siamese assembly (FIG. 82) which is described below.

ASSEMBLY CONFIGURATIONS: Two assembly configurations are discussed here using the above-mentioned modules and a Gear-Changing-Mechanism.

Namely:
1) Sequential configuration and
2) Siamese configuration.

The main difference is how the modules and the Gear-Changing-Mechanisms are arranged and the space and the envelope it occupies. The sequential configuration has a smaller foot print but taller than the Siamese configuration. The choice depends on the available envelope for the CVT Sequential Configuration (FIG. 76):

As shown in FIG. 44, the Shaft-Input 4 is mounted on Bearing-Input-Shaft 5 and placed in the center of a Frame-Main-Housing 1 (FIG. 3). The Driving-Non-Circular-Gear 8, the Intermediate-Circular-Gears-C2-C3 11, the Scotch-Yoke-Module along with the Ratio-Changing-Mechanism is mounted on the Shaft-Input 4. Here the Shaft-Input 4 is made to pass through the second slot, the Input-Shaft-Slot 1012 of the Cross-Rack-Holder 44. Shaft-Intermediate-Gear 6 is mounted on Bearing-Intermediate-Gear-Shaft 7 and placed in the center of the Frame-Main-Housing 1. The Driven-Non-Circular-Gear 9 along with Intermediate-Circular-Gear-C1 10 and intermediate-Circular-Gear-C4-C5 12 is mounted on Shaft-Intermediate-Gear 6 parallel to the Shaft-Input 4 at a distance “CTR”. The Intermediate-Circular-Gear-C2-C3 11, Intermediate-Circular-Gear-C4-C5 12 and the Input-Disk 16 have clearance fit such that they freewheel on their respective shafts. The powertrain flow from the Shaft-Input 4 to Input-Disk 16 is as per the table provided below.

| | | Type of |
|---|---|---|
| From | To | connection |
| Input-Shaft | Driven-Non-Circular-Gear | Axial, Rigid |
| Driven-Non-Circular-Gear | Driving-Non-Circular-Gear | Radial |
| Driving-Non-Circular-Gear | Intermediate gear 1 | Axial, Rigid |
| Intermediate gear 1 | Intermediate gear 2 | Radial |
| Intermediate gear 2 | Intermediate gear 3 | Axial, Rigid |
| Intermediate gear 3 | Intermediate gear 4 | Radial |
| Intermediate gear 4 | Intermediate gear 5 | Axial, Rigid |
| Intermediate gear 5 | Input-Disk | Radial |

While the working of the CVT can be accomplished just with Intermediate-Circular-Gears-C1 10, Intermediate-Circular-Gears-C4-C5 12 and Intermediate-Circular-Gears-C4a-C5a 20, the Intermediate-Circular-Gears-C2-C3 11 are used to achieve 1:1 ratio between the Driving-Non-Circular-Gear 8 to Input-Disk 16, if the ratio between the Driving-Non-Circular 8 gear and the Driven-Non-Circular gear 9 is not 1:1 or 1:1 where I is an integer or ½ depending on the relationship between the Driving-Non-Circular-Gear 8 and the Driven-Non-Circular-Gear 9.

Two Rectifier-Modules 1001 are placed next to the Cross-Rack-Holder 44 as shown in FIG. 83 such that the Rack 64 is placed normal to the Cross-Rack-Holder's 44 Crank-Pin-Slot 1013. When Planetary-Mechanism is used, the Crank-Pin 42 has a body shaped like rectangular prism with circular prism extended on both sides. One of them functions as a cam-follower, made to engage with the Ratio-Cam-Disk 18 and other functions as a Crank-Pin 42, and made to engage with the Rack 64 on the Cross-Rack-Holder 44. This entire assembly, except the Driving-Non-Circular-Gear 8 & Driven-Non-Circular-Gear 9 and the Shaft-Input 4, is duplicated and mirrored about the mid-plane of the longitudinal-axis of the Driving-Non-Circular-Gear 8, and rotated by 90°. The Driven-Non-Circular-Gear 9 is duplicated and rotated by 45° or 135° such that the Racks 64 are placed at 90° phase shift to the next. The Racks 64 are on All the four Rectifier-Modules 1001 share one common Shaft-Input 4 and one common Driving-Non-Circular-Gear 8. Two of the Rectifier-Modules 1001 share a common Input-Disk 16 and gear changing mechanism. To accommodate this, the Driven-Non-Circular-Gear 9 is oriented at 45° with the Driven-Non-Circular-Gear 9 phased at 45° relative to the other Driven-Non-Circular-Gear 9. Also due to the fact the non-circular-gears are symmetric it can be also oriented at 135°. This adds up to a 90° phase shift between Racks 64. This arrangement will allow reduction in the “foot print” of the entire assembly. If the ratio between the angular velocities of the Driving-Non-Circular gear 8 and the Driven-Non-Circular gear 9 is 1:1 or 1:2, the Input-Disk 16 can be directly connected to the Driven-Non-Circular-Gear 9 allowing the Intermediate-Circular-Gears-C1 to “free wheel” on its shaft.

The Cross-Rack-Holder 44 is free to move only along the direction of the Rack 64 and its movement is restricted by a Frame-Cross-Rack-Holder-Guide 2. A set of telescopic-sleeves, Sleeve-Primary-Telescopic 45 and Sleeve-Secondary-Telescopic 46 are placed on either side of the Cross-Rack-Holder 44. This will decrease the overall size needed for the Cross-Rack-Holder 44 and the Frame-Main-Housing 1. A prong placed on either side of the Cross-Rack-Holder 44 and another on the Sleeve-Secondary-Telescopic 46, to pull and extend the telescopic sleeves and the telescopic sleeves are collapsed by the body of the Cross-Rack-Holder 44. These telescopic-sleeves are caged-in by a Frame-Telescopic-Guide 3 (FIG. 4).

A Power-Link assembly (FIG. 60) is placed parallel to the One-Way-Bearing assembly (FIG. 59). The Power-Link assembly consists of a Shaft-Power-Link 52 (FIG. 8) that is mounted on two bearings that are placed on the Frame-Telescopic-Guide 3. A Output-Gear/Output-Sprocket 51 is placed on the Shaft-Power-Link's 52 each ends. The power from the Shaft-Pinion 48 is transmitted to the Power-Link through this Output-Gear/Output-Sprocket 51.

The main purpose of the Power-Link assembly is to link the output from each rectifier-module so that they are connected in sequence with a set overlap and there is a continuous output. The power-link assembly consists of a Shaft-Power-Link 52 that is mounted on two bearings that are placed on the Frame-Telescopic-Guide 3. A gear or sprocket is placed on the Shaft-Power-Link's 52 each ends. The power from the Shaft-Pinion 48 is transmitted to the Shaft-Power-Link 52 through this gear or sprocket. Siamese configuration (FIG. 82):

Here the construction is identical to the Sequential configuration except as noted below. In this alternative assembly configuration, the Scotch-Yoke-Module FIG. 85 and the Driven-Non-Circular-Gear 9 along with the Ratio-Changing-Mechanism are placed on the Shaft-Auxiliary-Input 66. The Input-Disk 16 and the Driven-Non-Circular-Gear 9 are directly connected to the Shaft-Auxiliary-Input 66. Here the need for the second slot, the Input-Slot, on the Cross-Rack-Holder 44 is eliminated. This eliminates the risk of Shaft-Input 4 slipping into Crank-Pin-Slot 1013 of the Cross-Rack-Holder 44 or the Crank-Pin 42 slipping in to the Input-Slot of the Cross-Rack-Holder 44. Depending on the selection of the ratio changing mechanism, the Shaft-Auxiliary-Input 66 shaft could have a circular cross section. This modular sub-assembly is placed parallel to the Shaft-Input 4, and mirrored about a plane containing the longitudinal axis of the Shaft-Input 4, such that the planes formed by the longitudinal axis of the Shaft-Input 4 and the longitudinal axis of the Shaft-Auxiliary-Input 66 form an angle equal to 135°. This configuration has the outputs from each Rectifier-Module 1001 to be placed on the same side of the frame. This allows linking of outputs using Output-Gear/Output-Sprocket 51 and chain and thereby eliminates the need for the Shaft-Power-Link 52. The Shaft-Input 4 is mounted on two Bearing-Input-Shaft 5 and placed in the center of the Frame-Main-Housing(s) 1 (FIG. 3). The Input-Disk 16 is mounted on the Shaft-Input 4 and sandwiched between the Rack-Holder (FIG. 10) and the Ratio-Cam-Disk 18 and the Crank-Pin 42 is caged in the slot, The Crank-Pin 42 has a body shaped like rectangular prism with circular prism extended on both sides. One of them functions as a cam-follower, made to engage with the Ratio-Cam-Disk 18 and other functions as a Crank-Pin 42, and made to engage with the Rack 64 on the Cross-Rack-Holder 44. Parallel to the Input-Disk 16 the Driving-Non-Circular-Gears is mounted on the Shaft-Input 4. The Shaft-Intermediate-Gear 6 (FIG. 7) is mounted on Bearing-Intermediate-Gear-Shaft 7, with one in each of the Frame-Main-Housing 1. The Shaft-Intermediate-Gear 6 is placed parallel to the Shaft-Input 4 at a distance “CTR” that is used to derive the shape of the non-circular gears. The powertrain flow from the Shaft-Input 4 to the Input-Disk 16 is as per the table provided below.

| | | Type |
|---|---|---|
| From | To | of connection |
| Input-Shaft | Driven-Non-Circular-Gear | Axial, Rigid |
| Driven-Non-Circular-Gear | Driving-Non-Circular-Gear | Radial |
| Driving-Non-Circular-Gear | Intermediate gear 1 | Axial, Rigid |
| Intermediate gear 1 | Intermediate gear 2 | Radial |
| Intermediate gear 2 | Intermediate gear 3 | Axial, Rigid |
| Intermediate gear 3 | Intermediate gear 4 | Radial |
| Intermediate gear 4 | Intermediate gear 5 | Axial, Rigid |
| Intermediate gear 5 | Input-Disk | Radial |

### Arrangement of Transmission of Power From Engine/Power Source to Input-Disk 16:

By using a set of non-circular gears, the Driving-Non-Circular-Gear 8 (FIG. 8) and the

Driven-Non-Circular-Gear 9 (FIG. 9), the rate of change in angular displacement at the Input-Disk 16 is altered. The output from the Shaft-Input 4 is transferred through a set of non-circular gears and then transferred to the Input-Disk 16 via five Intermediate-Circular-Gears. The Driving-Non-Circular-Gear 8 is mounted directly on the Shaft-Input 4. The Driven-Non-Circular-Gear 9 is mounted on the Shaft-Intermediate-Gear 6 (FIG. 7), which is mounted on two Bearing-Intermediate-Gear-Shaft 7 and placed on the two Frame-Main-Housing 1.

The Intermediate-Circular-Gear-C1 10 is mounted on the Shaft-Intermediate-Gear 6, with a direct connection to the Driven-Non-Circular-Gear 9. The Intermediate-Circular-Gears-C2-C3 11 (FIG. 25) is mounted on the Shaft-Input 4, free to spin with a Bearing-Circular-Gear-C2-C3 14. The Intermediate-Circular-Gears-C4-C5 12 (FIG. 26) is mounted on the Shaft-Intermediate-Gear 6 that is free to spin with a Bearing-Circular-Gear-C2-C3 14 and intermediate gear C5 drives the Input-Disk 16.

Reason behind the need for a circular gear between the non-circular gears when the pitch-curve 1006 interferes/multiple contacts at the same instant: This also can be eliminated by having multiple layers for the non-circular gears.

From the equations for the non-circular gear pitch-curves 1006, it can be seen that the radius of the Driven-Non-Circular-Gear 9 is lower than the Shaft-Input 4 it is mounted on over a wide region and reaches zero at two locations. In addition, there is a potential that, due to the shape of the pitch-curve 1006, the Driven-Non-Circular-Gear 9 and the Driving-Non-Circular-Gear 8 may have multiple contact points at a given time. This can be eliminated by inserting an Intermediate-Gear-Non-Circular-Gear-Connector 62 between the two non-circular gears. This increases the distance between the two non-circular gears and eliminates the issue of multiple contact point at any given time.

### Crank-Pin-Displacement-Mechanism:

Two concepts are used namely 1) Axis at slot intersection and 2) Axis on Rack.

Crank-Pin Axis at slot intersection: This can be achieved by rotating the Ratio-Cam-Disk 18 which has a slot with a certain profile. When the Ratio-Cam-Disk 18 is rotated with respect to the Input-Disk 16 this profile forces the Crank-pin 42 to move in radial direction of the disk's longitudinal axis. This is because the longitudinal axis of the Crank-pin 42 intersects the slot Input-Disk 16 and the slot in the Ratio-Cam-Disk 18. When the Crank-pin 42 is closer to the longitudinal axis 1021 of the Input-Disk 16 the stroke is shorter and since the work done is constant, the force is increased. Similarly, with the Crank-pin 42 is farther from the longitudinal axis 1021 of the Input-Disk 16, the stroke is longer and since the work done is constant, the force is decreased. The challenge here is to have the Ratio-Cam-Disk 18 and the Input-Disk 16 spinning synchronized during normal operation however, and when the ratio change is desired, the Input-Disk 16 and the Ratio-Cam-Disk 18 should have a relative angular velocity. By using one of the three mechanisms described below, a relative angular velocity between the Input-Disk 16 and the Ratio-Cam-Disk 18 can be achieved, when desired.

Crank-Pin Axis on the Rack: This method to change the location of the Crank-Pin 42 is shown in FIG. 91. Here a Spur-Gear 72 is mounted on the Disk-Input-Modified 75 and the Ratio-Cam-Disk-Modified 76 has a ring gear profile matching the Spur-Gear 72. The relative instantaneous rotation of the Disk-Input-Modified 75 and the Ratio-Cam-Disk-Modified 76 is used to spin the spur gear mounted on the Input-Disk 16, which in turn moves a Rack-Crank-Pin 73 attached to the Crank-Pin 42. Here the Rack-Crank-Pin 73 is placed in the Shaft-Notched-Input 74 as shown in FIG. 91 such that the Crank-Pin 42 can be moved co-axial with the Input-Disk 16 allowing a zero oscillation of the Rack 64.

### Concept Behind Using Telescopic—Sleeve to Enable Compact Design:

For this design to work the length of the input slot of the rack assembly has to be a value equal to 2*stroke+Input-Shaft diameter+2* minimum material thickness+2* the distance to reach the rack guide. This entire length has to be guided by the rack guide. Since the rack guide also has to accommodate the travel of the Rack 64, the opening portion of the rack guide should have a width at least as the diameter of the Input-Disk 16 or it will be out of reach when the Rack 64 travels to one side to the extreme. The telescopic-guide extends the support and as a result, the overall length of the rack assembly can be reduced by the “distance to reach the rack guide.” This also makes it possible for the Frame-Main-Housing Ito be shorter by that distance. Prongs are provided in the design of the rack assembly and in the Sleeve-Secondary-Telescopic 46 to extend the telescopic-sleeves. The body of the Cross-Rack-Holder 44 collapses the telescopic-sleeves.

### Concept Behind Use/Working Function of Retainer-Crank-Pin 71:

The Crank-Pin 42 is much smaller than the Shaft-Input 4. Since both the slots cross each other, there is a potential that the Crank-Pin 42 can slip in to the Input-Shaft slot. This is eliminated by using a Retainer-Crank-Pin 71 (FIG. 13) that is larger than the Input-Shaft slot. This is made to float in the Crank-Pin-slot enclosing the Crank-pin 42.

### Concept of Overlap of Power Transmission:

To ensure smooth transition from one Rectifier-Module 1001 to the next, for a brief period both the Rectifier-Modules 1001 are active and engage when the output from both of them reach a constant and uniform value. The overlap between each pair of adjacent Rectifier-Modules is substantially identical (FIGS. 68 and 69). The first Rectifier-Module 1001 disengages while it is still in the functional region 1017 and the second Rectifier-Module 1001 is well in the functional region 1017. The functional region 1017 of the non-circular gear can be defined as the region when in contact, the Rack 64 has a constant velocity. When the computer-controlled clutch is used, it links the Shaft-Pinion 48 to the Output-Gear/Output-Sprocket 51 , only when the Pinion 47 rotates in a specific direction and when the respective Driven-Non-Circular-Gears 9 are in a functional region 1017 as shown in FIG. 88.

### Modules and Their Assembly Layout and Constraints:

All the four Rectifier-Modules 1001 share one common Shaft-Input 4 and one common Driving-Non-Circular-Gear 8. Two of the Rectifier-Modules 1001 share a common Input-Disk 16 and a Gear-Changing-Mechanism. The Racks 64 are placed at 90° phase shift to the next. To accommodate this, the Driven-Non-Circular-Gear 9 is oriented at 45° with the Driven-Non-Circular-Gear 9 phased at 45° relative to the other Driven-Non-Circular-Gear 9. Also due to the fact the Non-Circular-Gears are symmetric it can be also oriented at 135°. This adds up to a 90° phase shift between Racks 64.

### Concept of Power Transfer/Link Between Modules:

When the Rectifier-Modules 1001 operate in sequence, they must be linked before the power is transferred to the Wheel-System 1022. This is achieved by using a Shaft-Power-Link 52 that has Output-Gear/Output-Sprocket 51 to link the output from each Rectifier-Module 1001 such that it has a continuous power to the Wheel-System 1022. The power is also transferred in sequence. The Rectifier-Modules 1001 are oriented such that their Non-Circular-Gears are in functional region 1017 in sequence with overlap 1016 (FIG. 69) when the Input-Disk 16 completes about one revolution, ensuring that at least one Rectifier-Module 1001 is in functional region 1017 at any given time, thus completing about one cycle.

### Reverse Gear Mechanism:

The output from the Shaft-CVT-Output 38 or the Co-Axial-Output-Element-With-Internal-Gear/Planetary-Gear 65 is coupled with Input-Shaft-For-Miter/Bevel-Gears 58. The output of these Miter/Bevel-Gear 59 will therefore rotate in opposite directions. The Miter/Bevel-Gear-Differential-Output-Shaft 61 of this differential-mechanism is placed co-axial to the output Miter/Bevel-Gear 59 with clearance so that it is free to spin independently with respect to the output Miter/Bevel-Gear 59. Two collars with a clutch are placed on the Jviiter/Bevel-Gear-Differential-Output-Shaft 61 allowing them to move axially. These can be made to link with either of the output Miter/Bevel-Gear 59, which rotate in opposite direction. When one of the collars is made to link via the Clutch-Park/Neutral/Reverse 60, by means of clutch, with a particular output Miter/Bevel-Gear 59 and the Miter/Bevel-Gear-Differential-Output-Shaft 61 will rotate in a particular direction. It will reverse its direction if the link is swapped to the other Miter/Bevel-Gear 59.

### Neutral Gear Mechanism:

When the collars are not in link via the Clutch-Park/Neutral/Reverse 60 with any of the Miter/Bevel-Gear 59, the collar and the e Miter/Bevel-Gear-Differential-Output-Shaft 61 is not restricted and, therefore, they are free to spin in any direction and function as a “neutral” gear.

### Park Mechanism:

When the collars are in link via the Clutch-Park/Neutral/Reverse 60 with both the Miter/Bevel-Gear 59, the collar is restricted from spinning and the Miter/Bevel-Gear-Differential-Output-Shaft 61 is totally restricted and, therefore, they are restricted to spin in any direction and functions as a “parking” gear.

### Feature and JVIechanism to Compensate Vibration:

1. Dummy-Crank-Pin 43: The Crank-Pin 42 is placed off-center when the Input-Disk 16 revolves. This imbalance will result in vibration. To compensate this, a Dummy-Crank-Pin 43 is placed at same distance 180° apart. This is moved by the same Ratio-Cam-Disk 18 that moves the Crank-Pin 42. This movement is identical to the movement of the Crank-Pin 42. The cam slots are made identical at 180° apart.

2. Dummy-Rack 55 for counter oscillation: As the Input-Disk 16 rotates the Cross-Rack-Holder 44 has an oscillatory motion which will result in vibration. It is cancelled by having an appropriate mass oscillating in the opposite direction. This is achieved by attaching a Wheel-Vibration-Cancellation-Mechanism 56 in contact with the Rack 64, which will spin back and forth. Bringing an appropriate mass in contact with the Wheel-Vibration-Cancellation-Mechanism 56 at 180° apart will compensate for this vibration.

### Co-Axial Input-Output Option Feature:

When co-axial input and output is desired, this can be achieved by adding a Co-Axial-Output-Element-With-Internal-Gear/Planetary-Gear 65 which has an internal gear, namely a ring gear placed co-axial with Shaft-Input 4. The Co-Axial-Output-Element-With-Internal-Gear/Planetary-Gear 65 will radially connect with all the Output-Gear I Output-Sprocket 51 and the Power-Link-Sprocket/Power-Link-Gear 54, directly or via an intermediate gears or planet gears of a planetary gear system.

### Converting CVT to an IVT (Infinitely-Variable-Transmission):

Having a co-axial input and output allows the CVT to function as a IVT. This can be achieved by adding a Planetary-Gear-System with a Sun-Gear, Ring-Gear and Planets supported by Carriers, and linking with Shaft-Input 4, the Co-Axial-Output-Element-With-Internal-Gear/Planetary-Gear 65.

The following are the options to achieve this:
a) The Shaft-Input 4 is directly linked to the Sun-Gear of the planetary-Gear-System with following 2 sub-options
   a. The Co-Axial-Output-Element-With-Internal-Gear/Planetary-Gear 65 is directly linked to the Carrier of the Planetary-Gear-System and Ring-Gear of the Planetary-Gear-System functions as the final output or wheel system 1022
   b. The Co-Axial-Output-Element-With-Internal-Gear/Planetary-Gear 65 is linked to the Ring-Gear of the Planetary-Gear-System and the Carrier functions as the final output or wheel system 1022.
b) The Co-Axial-Output-Element-With-Internal-Gear/Planetary-Gear 65 is directly linked to the Sun-Gear of the Planetary-Gear-System with following 2 sub-options.
   a. The Shaft-Input 4 is directly linked to the Carrier of the Planetary-Gear-System and the Ring-Gear of the Planetary-Gear-System and the Ring-Gear of the Planetary-Gear-System functions as the final output or wheel system 1022.
   b. The Shaft-Input 4 is directly linked to the Ring-Gear of the Planetary-Gear-System and the Carrier functions as the final output or wheel system.
c) The Shaft-Input 4 is directly linked to the Ring-Gear of the planetary-Gear-System with following 2 sub-options
   a. The Co-Axial-Output-Element-With-Internal-Gear/Planetary-Gear 65 is directly linked to the Carrier of the Planetary-Gear-System and Sun-Gear of the Planetary-Gear-System functions as the final output or wheel system 1022.
   b. The Co-Axial-Output-Element-With-Internal-Gear/Planetary-Gear 65 is linked to the Sun-Gear of the Planetary-Gear-System and the Carrier functions as the final output or wheel system 1022.
d) The Co-Axial-Output-Element-With-Internal-Gear/Planetary-Gear 65 is directly linked to the Ring-Gear of the Planetary-Gear-System with following 2 sub-options.
   a. The Shaft-Input 4 is directly linked to the Carrier of the Planetary-Gear-System and the Carrier of the Planetary-Gear-System and the Sun-Gear of the Planetary-Gear-System functions as the final output or wheel system 1022.
   b. The Shaft-Input 4 is directly linked to the Sun-Gear of the Planetary-Gear-System and the Carrier functions as the final output or wheel system 1022.
e) The Shaft-Input 4 is directly linked to the Carrier of the planetary-Gear-System with following 2 sub-options
   a. The Co-Axial-Output-Element-With-Internal-Gear/Planetary-Gear 65 is directly linked to the Ring-Gear of the Planetary-Gear-System and Sun-Gear of the Planetary-Gear-System functions as the final output or wheel system 1022.
   b. The Co-Axial-Output-Element-With-Internal-Gear/Planetary-Gear 65 is linked to the Sun-Gear of the Planetary-Gear-System and the Sun-Gearr functions as the final output or wheel system 1022.
f) The Co-Axial-Output-Element-With-Internal-Gear/Planetary-Gear 65 is directly linked to the Carrier of the Planetary-Gear-System with following 2 sub-options.
   a. The Shaft-Input 4 is directly linked to the Ring-Gear of the Planetary-Gear-System and the Ring-Gear of the Planetary-Gear-System and the Sun-Gear of the Planetary-Gear-System functions as the final output or wheel system 1022.
   b. The Shaft-Input 4 is directly linked to the Sun-Gear of the Planetary-Gear-System and the Ring-Gear functions as the final output or wheel system 1022.

In other words, The Co-Axial-Output-Element-With-Internal-Gear/Planetary-Gear 65 is connected to one of the three elements, either a Ring-Gear, a Carrier, or a Sun-Gear of a Planetary-Gear-System. The Shaft-Input 4 is connected to one of the remaining two elements of the Planetary-Gear-System. The third remaining element of the Planetary-System functions as the final output or wheel system 1022. This converts the CVT to an IVT.

### Concept of Temporary Storage of Power in a Flywheel:

When the power from the engine or power source is not transmitted to the final output or the wheel system, the power can be transferred to a flywheel system 1023 temporarily and transferred back to Shaft-Input 4 and then to the final output or the wheel system 1022 or directly to the final output or wheel system 1022 when desired.

Compensating for Deviation in Rack Movement with Cams:

It is beneficial to have smooth and gradual transitions in the rack movement profile to improve the life of the transmission. As shown in FIG. 97, the ideal rack velocity profile is as follows:
1. gradual increase in acceleration from rest 1025
2. a region of constant acceleration 1026
3. gradual reduction in acceleration to a constant velocity 1027
4. a region of constant velocity 1028
5. gradual increase in deceleration to a constant deceleration 1029
6. a region of constant deceleration 1030
7. gradual reduction in deceleration to zero velocity 1031
8. steps 1 through 7 above repeated in the opposite direction

It may not always be possible to generate perfect non-circular gears to meet the above desired Rack 64 movement. If the pitch curves 1006 of the Non-Circular-Gears 8 & 9 do not to achieve this desired Rack 64 movement, a Cam-Spring 81 and a planetary system can be used to compensate for any deviations from the desired Rack 64 movement profile. To achieve this, a Stationary Sun Gear 79 with respective to the frame is placed co-axial with the Driven-Non-Circular-Gear 9 as shown in FIG. 95. One or more Shaft-Cam 82 is placed on the Driven-Non-Circular-Gear 9. A Cam-Gear 77 is rigidly attached with a planetary gear on the carriers. This Cam-Gear 77 is made to engage another Cam-Input-Shaft 78 which is rigidly attached on Shaft-Intermediate-Gear 6 or Shaft-Notched-Input 74 or Shaft-Auxiliary-Input 66 to compensate any deviation in the desired movement and avoid abrupt changes in the Rack 64 velocity.

### Development of Mathematical Model:

The main aim is to determine a mathematical formula for the pitch-curves 1006 of the non-circular gears such that v_{rack} (linear velocity of the Rack 64) is constant. Pitch-curves 1006 are needed to develop non-circular gears.

The pitch curves for the Driving-Non-Circular-Gear 8 and Driven-Non-Circular-Gear 9, when expressed using Cartesian coordinates (X₁, Y₁) and (X₂, Y₂) respectively, as a function of an angle θ are,

$${X}_{1} is substantially = \frac{CTR * \frac{d Φ ( θ )}{d θ}}{1 + \frac{d Φ ( θ )}{d θ}} * cos ( θ ) , {Y}_{1} is substantially = \frac{CTR * \frac{d Φ ( θ )}{d θ}}{1 + \frac{d Φ ( θ )}{d θ}} * sin ( θ )$$

$${X}_{2} is substantially = \frac{CTR}{1 + \frac{d Φ ( θ )}{d θ}} * cos ( Φ ( θ ) ) , {Y}_{2} is substantially = \frac{CTR}{1 + \frac{d Φ ( θ )}{d θ}} sin ( Φ ( θ ) )$$

where Φ(θ) is a solution to a piece-wise differential-equation that uses a Sine function

$$N * \frac{d Φ}{d θ} * sin ( N * θ ) = G ( θ )$$

$$Where G ( θ ) = \\ \frac{{k}_{i} * ( θ - \frac{2 * π * i}{N * n} )}{( {θ}_{{1}_{i}} - \frac{2 * π * i}{N * n} )} if \frac{2 * π * i}{N * n} < θ < {θ}_{{1}_{i}}$$

$${k}_{1} if {θ}_{{1}_{i}} < θ < {θ}_{{2}_{i}}$$

$${k}_{i} - 2 * \frac{{k}_{i} * ( θ - {θ}_{{2}_{i}} )}{( {θ}_{{3}_{i}} - {θ}_{{2}_{i}} )} if {θ}_{{2}_{i}} < θ < {θ}_{{3}_{i}} \\ - {k}_{i} if {θ}_{{3}_{i}} < θ < {θ}_{{4}_{i}} \\ - {k}_{i} + \frac{{k}_{i} * ( θ - {θ}_{{4}_{i}} )}{( \frac{2 * π * ( i + 1 )}{N * n} - {θ}_{{4}_{i}} )} if {θ}_{{4}_{i}} < θ < \frac{2 * π * ( i + 1 )}{N * n}$$

Where the boundary conditions are:

$$Φ ( 0 ) = 0$$

$$Φ ( {θ}_{{1}_{i}} ) = \frac{Δ + 2 * π * i}{N}$$

$$Φ ( {θ}_{{2}_{i}} ) = \frac{π - Δ + 2 * π * i}{N}$$

$$Φ ( {θ}_{{3}_{i}} ) = \frac{π + Δ + 2 * π * i}{N}$$

$$Φ ( {θ}_{{4}_{i}} ) = \frac{2 * π - Δ + 2 * π * i}{N}$$

$$Φ ( \frac{π + 2 * π * i}{N * n} ) = \frac{π + 2 * π * i}{N}$$

Or a differential equation using a Cosine function

$$N * \frac{d Φ}{d θ} * cos ( N * φ ) = \\ {k}_{i} , if \frac{i * 2 * π}{N * n} < θ < {θ}_{{1}_{i}}$$

$${k}_{i} - 2 * \frac{{k}_{i} * ( θ - {θ}_{{1}_{i}} )}{( {θ}_{{2}_{i}} - {θ}_{{1}_{i}} )} , if {θ}_{{1}_{i}} < θ < {θ}_{{2}_{i}} , \\ - {k}_{i} , if {θ}_{{2}_{i}} < θ < {θ}_{{3}_{i}} , \\ - {k}_{i} + 2 * \frac{{k}_{i} * ( θ - {θ}_{{3}_{i}} )}{( {θ}_{{4}_{i}} - {θ}_{{3}_{i}} )} , if {θ}_{{3}_{i}} < θ < {θ}_{{4}_{i}} , \\ {k}_{i} , if {θ}_{{4}_{i}} < θ < \frac{( i + 1 ) * 2 * π}{N * n}$$

With the boundary conditions below:

$$Φ ( 0 ) = 0$$

$$Φ ( {θ}_{{1}_{i}} ) = \frac{\frac{π}{2} - Δ + 2 * π * i}{N}$$

$$Φ ( {θ}_{{2}_{i}} ) = \frac{\frac{π}{2} + Δ + 2 * π * i}{N}$$

$$Φ ( {θ}_{{3}_{i}} ) = \frac{\frac{3 * π}{2} - Δ + 2 * π * i}{N}$$

$$Φ ( {θ}_{{4}_{i}} ) = \frac{\frac{3 * π}{2} + Δ + 2 * π * i}{N}$$

$$Φ ( \frac{2 * π * ( i + 1 )}{N * n} ) = \frac{2 * π * ( i + 1 )}{N}$$

Where θ is angular displacement of the Driving-Non-Circular-Gear 8
Φ is the angular position of the Driven-Non-Circular-Gear 9
θ₁_{ᵢ}, θ₂_{ᵢ}, θ₃_{ᵢ}, θ₄_{ᵢ} are specific values of angular position of the Driving-Non-Circular-Gear 8 to be solved where the ranges from θ₁_{ᵢ} to θ₂_{ᵢ} and θ₃_{ᵢ} to θ₄_{ᵢ} are functional regions 1017 and

$$\frac{2 * π * i}{N * n}$$

to θ₁_{ᵢ} and θ₂_{ᵢ} to θ₃_{ᵢ} and θ₄_{ᵢ} to

$$\frac{2 * π * ( i + 1 )}{N * n}$$

are non-functional regions
kᵢ is an unknown constant that needs to be solved for using the boundary conditions for the Input-Disk 16 ith rotation
the constant of integration also needs to be solved for using boundary conditions
Δ is the cutoff angle between the first functional and non-functional regions
N is the number of times the Input-Disk 16 rotates when the Driven-Non-Circular-Gear 9 rotates once
n is the number of times the Driven-Non-Circular-Gear 9 rotates when the Driving-Non-Circular-Gear 8 rotates once
i refers to the ith rotation of the Input-Disk 16 starting with i=0 and going up to i=N*n−1

In our simple design, the following parameters were used:N=2, n=2. So using the Sine function

$$2 * \frac{d Φ}{d θ} * sin ( 2 * θ ) = G ( θ )$$

$$Where G ( θ ) = \frac{{k}_{0} * ( θ )}{( {θ}_{{1}_{o}} )} if 0 < θ < {θ}_{{1}_{o}}$$

$${k}_{0} if {θ}_{{1}_{o}} < θ < {θ}_{{2}_{o}}$$

$${k}_{0} - 2 * \frac{{k}_{0} * ( θ - {θ}_{{2}_{o}} )}{( {θ}_{{3}_{o}} - {θ}_{{2}_{o}} )} if {θ}_{{2}_{o}} < θ < {θ}_{{3}_{o}} \\ - {k}_{0} if {θ}_{{3}_{o}} < θ < {θ}_{{4}_{o}} \\ - {k}_{0} + \frac{{k}_{0} * ( θ - {θ}_{{4}_{o}} )}{( \frac{2 * π}{4} - {θ}_{{4}_{o}} )} if {θ}_{{4}_{o}} < θ < \frac{2 * π}{4}$$

$$\frac{{k}_{1} * ( θ - \frac{2 * π}{4} )}{( {θ}_{{1}_{1}} - \frac{2 * π}{4} )} if \frac{2 * π}{4} < θ < {θ}_{{1}_{1}}$$

$${k}_{1} if {θ}_{{1}_{1}} < θ < {θ}_{{2}_{1}}$$

$${k}_{1} - 2 * \frac{{k}_{1} * ( θ - {θ}_{{2}_{1}} )}{( {θ}_{{3}_{1}} - {θ}_{{2}_{1}} )} if {θ}_{{2}_{1}} < θ < {θ}_{{3}_{1}} \\ - {k}_{1} if {θ}_{{3}_{1}} < θ < {θ}_{{4}_{1}} \\ - {k}_{1} + \frac{{k}_{1} * ( θ - {θ}_{{4}_{1}} )}{( \frac{4 * π}{4} - {θ}_{{4}_{1}} )} if {θ}_{{4}_{1}} < θ < \frac{4 * π}{4}$$

$$\frac{{k}_{2} * ( θ - \frac{4 * π}{4} )}{( {θ}_{{1}_{2}} - \frac{4 * π}{4} )} if \frac{4 * π}{4} < θ < {θ}_{{1}_{2}}$$

$${k}_{2} if {θ}_{{1}_{2}} < θ < {θ}_{{2}_{2}}$$

$${k}_{2} - 2 * \frac{{k}_{2} * ( θ - {θ}_{{2}_{2}} )}{( {θ}_{{3}_{2}} - {θ}_{{2}_{2}} )} if {θ}_{{2}_{2}} < θ < {θ}_{{3}_{2}} \\ - {k}_{2} if {θ}_{{3}_{2}} < θ < {θ}_{{4}_{2}} \\ - {k}_{2} + \frac{{k}_{2} * ( θ - {θ}_{{4}_{2}} )}{( \frac{6 * π}{4} - {θ}_{{4}_{2}} )} if {θ}_{{4}_{2}} < θ < \frac{6 * π}{4}$$

$$\frac{{k}_{3} * ( θ - \frac{6 * π}{4} )}{( {θ}_{{1}_{3}} - \frac{6 * π}{4} )} if \frac{6 * π}{4} < θ < {θ}_{{1}_{3}}$$

$${k}_{3} if {θ}_{{1}_{3}} < θ < {θ}_{{2}_{3}}$$

$${k}_{3} - 2 * \frac{{k}_{3} * ( θ - {θ}_{{2}_{3}} )}{( {θ}_{{3}_{3}} - {θ}_{{2}_{3}} )} if {θ}_{{2}_{3}} < θ < {θ}_{{3}_{3}} \\ - {k}_{3} if {θ}_{{3}_{3}} < θ < {θ}_{{4}_{3}} \\ - {k}_{3} + \frac{{k}_{3} * ( θ - {θ}_{{4}_{3}} )}{( \frac{8 * π}{4} - {θ}_{{4}_{3}} )} if {θ}_{{4}_{3}} < θ < \frac{8 * π}{4}$$

And the boundary conditions are:

$$Φ ( 0 ) = 0$$

$$Φ ( {θ}_{{1}_{o}} ) = \frac{Δ}{2}$$

$$Φ ( {θ}_{{2}_{o}} ) = \frac{π - Δ}{2}$$

$$Φ ( {θ}_{{3}_{o}} ) = \frac{π + Δ}{2}$$

$$Φ ( {θ}_{{4}_{o}} ) = \frac{2 * π - Δ}{2}$$

$$Φ ( \frac{π}{4} ) = \frac{π}{2}$$

$$Φ ( {θ}_{{1}_{1}} ) = \frac{Δ + 2 * π}{2}$$

$$Φ ( {θ}_{{2}_{1}} ) = \frac{π - Δ + 2 * π}{2}$$

$$Φ ( {θ}_{{3}_{1}} ) = \frac{π + Δ + 2 * π}{2}$$

$$Φ ( {θ}_{{4}_{1}} ) = \frac{2 * π - Δ + 2 * π}{2}$$

$$Φ ( \frac{3 * π}{4} ) = \frac{3 * π}{2}$$

$$Φ ( {θ}_{{1}_{2}} ) = \frac{Δ + 4 * π}{2}$$

$$Φ ( {θ}_{{2}_{2}} ) = \frac{π - Δ + 4 * π}{2}$$

$$Φ ( {θ}_{{3}_{2}} ) = \frac{π + Δ + 4 * π}{2}$$

$$Φ ( {θ}_{{4}_{2}} ) = \frac{2 * π - Δ + 4 * π}{2}$$

$$Φ ( \frac{5 * π}{4} ) = \frac{5 * π}{2}$$

$$Φ ( {θ}_{{1}_{3}} ) = \frac{Δ + 6 * π}{2}$$

$$Φ ( {θ}_{{2}_{3}} ) = \frac{π - Δ + 6 * π}{2}$$

$$Φ ( {θ}_{{3}_{3}} ) = \frac{π + Δ + 6 * π}{2}$$

$$Φ ( {θ}_{{4}_{3}} ) = \frac{2 * π - Δ + 6 * π}{2}$$

$$Φ ( \frac{7 * π}{4} ) = \frac{7 * π}{2}$$

Using the Cosine function we get

$$2 * \frac{d Φ}{d θ} * cos ( 2 * φ ) = \\ {k}_{0} , if 0 < θ < {θ}_{{1}_{0}}$$

$${k}_{0} - 2 * \frac{{k}_{0} * ( θ - {θ}_{{1}_{0}} )}{( {θ}_{{2}_{0}} - {θ}_{{1}_{0}} )} , if {θ}_{{1}_{0}} < θ < {θ}_{{2}_{0}} , \\ - {k}_{0} , if {θ}_{{2}_{0}} < θ < {θ}_{{3}_{0}} , \\ - {k}_{0} + 2 * \frac{{k}_{0} * ( θ - {θ}_{{3}_{0}} )}{( {θ}_{{4}_{0}} - {θ}_{{3}_{0}} )} , if {θ}_{{3}_{0}} < θ < {θ}_{{4}_{0}} , \\ {k}_{0} , if {θ}_{{4}_{0}} < θ < \frac{2 * π}{4}$$

$${k}_{1} , if \frac{2 * π}{4} < θ < {θ}_{{1}_{1}}$$

$${k}_{1} - 2 * \frac{{k}_{1} * ( θ - {θ}_{{1}_{1}} )}{( {θ}_{{2}_{1}} - {θ}_{{1}_{1}} )} , if {θ}_{{1}_{1}} < θ < {θ}_{{2}_{1}} , \\ - {k}_{1} , if {θ}_{{2}_{1}} < θ < {θ}_{{3}_{1}} , \\ - {k}_{1} + 2 * \frac{{k}_{1} * ( θ - {θ}_{{3}_{1}} )}{( {θ}_{{4}_{1}} - {θ}_{{3}_{1}} )} , if {θ}_{{3}_{1}} < θ < {θ}_{{4}_{1}} , \\ {k}_{1} , if {θ}_{{4}_{1}} < θ < \frac{4 * π}{4}$$

$${k}_{2} , if \frac{4 * π}{4} < θ < {θ}_{{1}_{2}}$$

$${k}_{2} - 2 * \frac{{k}_{2} * ( θ - {θ}_{{1}_{2}} )}{( {θ}_{{2}_{2}} - {θ}_{{1}_{2}} )} , if {θ}_{{1}_{2}} < θ < {θ}_{{2}_{2}} , \\ - {k}_{2} , if {θ}_{{2}_{2}} < θ < {θ}_{{3}_{2}} , \\ - {k}_{2} + 2 * \frac{{k}_{2} * ( θ - {θ}_{{3}_{2}} )}{( {θ}_{{4}_{2}} - {θ}_{{3}_{2}} )} , if {θ}_{{3}_{2}} < θ < {θ}_{{4}_{2}} , \\ {k}_{2} , if {θ}_{{4}_{2}} < θ < \frac{6 * π}{4}$$

$${k}_{3} , if \frac{6 * π}{4} < θ < {θ}_{{1}_{3}}$$

$${k}_{3} - 2 * \frac{{k}_{3} * ( θ - {θ}_{{1}_{3}} )}{( {θ}_{{2}_{3}} - {θ}_{{1}_{3}} )} , if {θ}_{{1}_{3}} < θ < {θ}_{{2}_{3}} , \\ - {k}_{3} , if {θ}_{{2}_{3}} < θ < {θ}_{{3}_{3}} , \\ - {k}_{3} + 2 * \frac{{k}_{3} * ( θ - {θ}_{{3}_{3}} )}{( {θ}_{{4}_{3}} - {θ}_{{3}_{3}} )} , if {θ}_{{3}_{3}} < θ < {θ}_{{4}_{3}} , \\ {k}_{3} , if {θ}_{{4}_{3}} < θ < \frac{8 * π}{4}$$

Where the boundary conditions are:

$$Φ ( 0 ) = 0$$

$$Φ ( {θ}_{{1}_{0}} ) = \frac{\frac{π}{2} - Δ}{2}$$

$$Φ ( {θ}_{{2}_{0}} ) = \frac{\frac{π}{2} + Δ}{2}$$

$$Φ ( {θ}_{{3}_{0}} ) = \frac{\frac{3 * π}{2} - Δ}{2}$$

$$Φ ( {θ}_{{4}_{0}} ) = \frac{\frac{3 * π}{2} + 6}{2}$$

$$Φ ( \frac{2 * π}{4} ) = \frac{2 * π}{2}$$

$$Φ ( {θ}_{{1}_{1}} ) = \frac{\frac{π}{2} - Δ + 2 * π}{2}$$

$$Φ ( {θ}_{{2}_{1}} ) = \frac{\frac{π}{2} + Δ + 2 * π}{2}$$

$$Φ ( {θ}_{{3}_{1}} ) = \frac{\frac{3 * π}{2} - Δ + 2 * π}{2}$$

$$Φ ( {θ}_{{4}_{1}} ) = \frac{\frac{3 * π}{2} + Δ + 2 * π}{2}$$

$$Φ ( \frac{4 * π}{4} ) = \frac{4 * π}{2}$$

$$Φ ( {θ}_{{1}_{2}} ) = \frac{\frac{π}{2} - Δ + 4 * π}{2}$$

$$Φ ( {θ}_{{2}_{2}} ) = \frac{\frac{π}{2} + Δ + 4 * π}{2}$$

$$Φ ( {θ}_{{3}_{2}} ) = \frac{\frac{3 * π}{2} - Δ + 4 * π}{2}$$

$$Φ ( {θ}_{{4}_{2}} ) = \frac{\frac{3 * π}{2} + Δ + 4 * π}{2}$$

$$Φ ( \frac{6 * π}{4} ) = \frac{6 * π}{2}$$

$$Φ ( {θ}_{{1}_{3}} ) = \frac{\frac{π}{2} - Δ + 6 * π}{2}$$

$$Φ ( {θ}_{{2}_{3}} ) = \frac{\frac{π}{2} + Δ + 6 * π}{2}$$

$$Φ ( {θ}_{{3}_{3}} ) = \frac{\frac{3 * π}{2} - Δ6 * π}{2}$$

$$Φ ( {θ}_{{4}_{3}} ) = \frac{\frac{3 * π}{2} + Δ + 6 * π}{2}$$

$$Φ ( \frac{8 * π}{4} ) = \frac{8 * π}{2}$$

In the most general form, Φ(θ) is a solution to a piece-wise differential-equation

$$N * \frac{d Φ}{d θ} * sin ( N * φ ) =$$

function of any linear or nonlinear curve connecting the points

$$( \frac{i * 2 * π}{N * n} , 0 ) to ( {θ}_{{1}_{i}} , {k}_{i} ) if \frac{i * 2 * π}{N * n} < θ < {θ}_{{1}_{i}} ,$$

kᵢ if θ₁_{ᵢ}<θ<θ₂_{ᵢ},
   function of any linear or nonlinear curve connecting the points (θ₂_{ᵢ}, kᵢ) to (θ₃_{ᵢ}, −kᵢ)
if θ₂_{ᵢ}<θ<θ₃_{ᵢ},
−kᵢ if θ₃_{ᵢ}<θ<θ₄_{ᵢ},
   function of any linear or nonlinear curve connecting the points (θ₄_{ᵢ}, −kᵢ) to

$$( \frac{( i + 1 ) * 2 * π}{N * n} , 0 ) if {θ}_{{4}_{i}} < θ < \frac{( i + 1 ) * 2 * π}{N * n} , OR N * \frac{d Φ}{d θ} * cos ( N * φ ) =$$

kᵢ if

$$\frac{i * 2 * π}{N * n} < θ < {θ}_{{1}_{i}} ,$$

function of any linear or nonlinear curve connecting the points (θ₁_{ᵢ}, kᵢ) to (θ₂_{ᵢ}, −kᵢ)
if θ₁_{ᵢ}<θ<θ₂_{ᵢ},
−kᵢ, if θ₂_{ᵢ}<θ<θ₃_{ᵢ},
   function of any linear or nonlinear curve connecting the points (θ₃_{ᵢ}, −kᵢ) to (θ₄_{ᵢ}, kᵢ),
if θ₃_{ᵢ}<θ<θ₄_{ᵢ},
kᵢ, if

$${θ}_{{4}_{i}} < θ < \frac{( i + 1 ) * 2 * π}{N * n} ,$$

Where the boundary conditions are

$$Φ ( 0 ) = 0$$

$$Φ ( \frac{( i + 1 ) * 2 * π}{N * n} ) = \frac{( i + 1 ) * 2 * π}{N}$$

$$Φ ( {θ}_{{1}_{i}} ) = \frac{i * 2 * π}{N} + {Φ}_{1}$$

$$Φ ( {θ}_{{2}_{i}} ) = \frac{i * 2 * π}{N} + {Φ}_{2}$$

$$Φ ( {θ}_{{3}_{i}} ) = \frac{i * 2 * π}{N} + {Φ}_{3}$$

$$Φ ( {θ}_{{4}_{i}} ) = \frac{i * 2 * π}{N} + {Φ}_{4}$$

### Where

θ is the angular displacement of the Driving-Non-Circular-Gear
Φ is the angular displacement of the Driven-Non-Circular-Gear
i refers to the i-th revolution the Input-Disk from 0 to N*n−1 with the 1^{st} rotation being i=0;
N is the number of times the Input-Disk spins when the Driven-Non-Circular-Gear spins once; The value of N will depend on the radii of the intermediate circular gears.
n is the number of times the Driven-Non-Circular-Gear spins when the Driving-Non-Circular-Gear spins once;
the regions where the piece-wise function is constant are functional regions and the regions where the piece-wise function is not constant are non-functional regions which can be linear or non-linear functions of θ;
θ₁_{ᵢ}, θ₂_{ᵢ}, θ₃_{ᵢ} and θ₄_{ᵢ} are specific angular positions of the Driving-Non-Circular-Gear, the values of which need to be solved for using the solution to the differential equation;
Φ₁, Φ₂, Φ₃ and Φ₄ are specific angular positions of the Driven-Non-Circular-Gear corresponding to angular positions θ₁_{ᵢ}, θ₂_{ᵢ}, θ₃_{ᵢ} and θ₄_{ᵢ} of the Driving-Non-Circular-Gear respectively, and are the cutoff between functional and non-functional regions the values of which need to be chosen;
k_{i are} constants which needs to be solved for, however would be all equal;
Where “i” refers to the ith rotation of the Input-Disk 16 with the 1^{st} rotation being i=0

The piece-wise function can be set up for a 1 whole cycle of the rack movement function or multiple cycles, or part of a cycle (only if using symmetric rack movement function). Reflection techniques can be used to get the complete pitch curve for the driving and driven non-circular gears.
tₙ₊₁_{ᵢ} can be related to tₙ_{ᵢ} using symmetry conditions or treated as unrelated to each other using another set of boundary conditions.
tₙ₊₁_{ᵢ} can be related to tₙ_{ᵢ} using cycle period equation or treated as unrelated to each other using another set of boundary conditions.
The same constant k can be used all the way through or treated as different in each term and solved for using appropriate boundary conditions, however they would all have the same values.
Appropriate remaining boundary conditions can be chosen to solve for the remaining unknown variables.
The pitch-curves of the Driving-Non-Circular-Gear and the Driven-Non-Circular-Gear have maximal and minimal values for the radius and multiple parts which can be derived from each other by successive mirroring about appropriate planes. This is shown in FIGS. 89 and 90 where the four parts 1007 of each of the Non-Circular-Gears can be derived by mirroring each other.

### Compensating for Force Required to Move the Crank Pin to Change Input to Output Ratio:

It will take a large amount of force to be applied on the Lever-Ratio-Changing-Planetary-mechanism 23 to move the Crank-Pin 42 since it is opposing the load from the output. This force is dependent on the torque required to overcome the load on the output by the Input-Disk 16, the angle of the input slot to the direction of Rack 64 movement and the distance of the Crank-Pin 42 to axis of rotation of the Input-Disk 16. The direction and magnitude of this force changes as shown in the graph in FIG. 98, as an example, when two Angular-Velocity-Modifier-Modules are used.

Here,
the force acting on one Angular-Velocity-Modifier-Module is R_{f}cos (Φₐ(θ)) and
the other Angular-Velocity-Modifier-Module is R_{f}sin (Φ_{b}(θ))
and the sum is
R_{f}cos (Φₐ(θ))+R_{f}sin(Φ_{b}(θ)),
where
R_{f} is the force experienced by the Rack 64 of the respective module at any given time. (Φₐ(θ)) and (Φ_{b}(θ)) are angles of rotation (Φ) of the two Driven-Non-Circular-Gears 9 which are functions of the rotation of the Driving-Non-Circular-Gear (θ). A graph showing this force as a function of the angular displacement of the Driving-Non-Circular-Gear 8 is shown in FIG. 98. The portions of the graph 1032 and 1033, show the magnitude and direction of the force exerted by the rack connected to the first Angular-Velocity-Modifier-Module. The portions of the graph 1034 and 1035, show the magnitude and direction of the force exerted by the rack connected to the second Angular-Velocity-Modifier-Module. A pair of Spring-Force-Compensation 80 can be used to assist in overcoming this force for each Angular-Velocity-Modifier-Module.

The two Spring-Force-Compensation 80 are attached the operating Lever-Ratio-Changing-Planetary-Mechanism 23 acting on the Cam-Input-Shaft 78 (as shown in FIG. 96) will exert force in the opposite direction of the load from the output.

Springs with a spring constant that it close to the the average value of the force required when the Crank-Pin 42 is at its two extreme positions, over the distance of the two extreme position can be chosen.

1. An infinitely variable transmission wherein:
At least one Scotch-Yoke-Module which consists of:
a) an Input-Disk having a radial slot with a length extending in a substantially radial direction, disposed between a Ratio-Cam-Disk comprising a non-radial slot extending at least partially in a non-radial direction, and a slotted Cross-Rack-Holder comprising a first slot for receiving a Crank-Pin, a longitudinal axis of the first slot being orthogonal to a longitudinal axis of a Rack coupled with the slotted Cross-Rack-Holder that is restricted to move only along a substantially straight line that is substantially orthogonal to the first slot, a Crank-Pin engaged in the slot on the Input-Disk, the first slot of the Cross-Rack-Holder, and the slot of the Ratio-Cam-Disk 18, and extending parallel to a longitudinal axis of the Input-Disk,
b) at least one Rectifier-Module that includes:
the Rack, a Pinion, a Shaft-Pinion, a One-Way-Bearing or a Ratchet-Mechanism or a Computer-Controlled-Clutch, and an Output-Gear or an Output-Sprocket
and c) an Angular-Velocity-Modifier-Module comprising at least one Non-Circular-Gear and an Input-Shaft, arranged such that
a uniform rotation of at least one Driving-Non-Circular-Gear rotates at least one Driving-Non-Circular-Gear about its longitudinal-axis causes a non-uniform angular velocity of the Input-Disk about its longitudinal-axis which via the slot of the Input-Disk causes the Crank-Pin to reciprocate the Rack substantially orthogonal to its slot at a constant velocity and slowing down to a stop followed by an acceleration in the opposite direction to a constant reciprocating the Rack coupled there to rock the Pinion and this rocking movement of the Pinion is converted to unidirectional rotation of an Output-Gear or an Output-Sprocket via at least one of a One-Way-Bearing, a Ratchet-Mechanism, or a Computer-Controlled-Clutch; where the driven non circular gear further functions as a carrier of a planetary gear system, housing at least one free to spin planet gear that is attached to a gear cam that meshes with a stationary ring gear or a stationary sun gear operably engaging the gear cam with a shaft cam that is mounted on the Input-Shaft to compensate for any deviation in the desired rack movement in the functional region.

2. The infinitely variable transmission of claim 1, wherein the Ratio-Cam-Disk and the Input-Disk are positioned adjacent and coaxial to one another, and are controllable to rotate synchronously or non-synchronously by a Synchronous-Control-Mechanism and when they rotate substantially synchronously, a distance between the Crank-Pin and a central axis of the Input-Disk is maintained at a substantially constant distance, where this distance ranges from zero to the length of the radial slot of the Input-Disk, and any non-synchronous rotation will alter the distance between the Crank-Pin and the central axis of the Input-Disk by a Crank-Pin-Displacement-Mechanism; wherein the Synchronous-Control-Mechanism comprises two sets of an axially connected pair of Intermediate-Circular-Gears, wherein for each axially connected pair of Intermediate-Circular-Gears, the circular gears of the pair are dissimilar in size, and one of the gears from one of the sets is configured to radially connect to the Input-Disk and one of the gears from the other of the sets is configured to radially connect with the Ratio-Cam-Disk, where the Input-Disk and the Ratio-Cam-Disk have gear profile with substantially identical pitch curve on their circumference/perimeter, and wherein each longitudinal axis of the Intermediate-Circular-Gear is parallel to the axis of the Input-Disk, and further wherein the axes of the Intermediate-Circular-Gears are movable along a slot, thru a lever or cable, that is at a substantially constant distance from the longitudinal axis of the Input-Disk. wherein the Input-Disk and Ratio-Cam-Disk rotate substantially synchronously when the axes of the Intermediate-Circular-Gears remain substantially stationary, otherwise the Input-Disk and the Ratio-Cam-Disk rotate non-synchronously. wherein the driven non-circular-gear is paired with a cam which pushes the lever or cable via a spring to assist the lever or cable movement.
